(19) United States
(12) Patent Application Publication
(10) Pub. No.: US 2011/0119425 A1
(43) Pub. Date: May 19, 2011

(54) DETACHABLE INTERCONNECT FOR CONFIGURABLE WIDTH MEMORY SYSTEM

(75) Inventors: Ravindranath Kollipara, Palo Alto, CA (US); Xingchao Yuan, Palo Alto, CA (US); Frank Lambrecht, mountain View, CA (US); Ming Li, Fremont, CA (US); Richard E. Perego, Thornton, CO (US); Qi Lin, Mountain View, CA (US); David Nguyen, Cupertino, CA (US); Kyung Suk Oh, Campbell, CA (US)

(73) Assignee: RAMBUS INC., Los Altos, CA (US)

(21) Appl. No.: 12/675,105

(22) PCT Filed: Jun. 30, 2008
(86) PCT No.: PCT/US2008/068822

§ 371 Date: Feb. 24, 2010

Related U.S. Application Data
(60) Provisional application No. 60/968,523, filed on Aug. 28, 2007.

(51) Int. Cl. G06F 13/40; G06F 13/20

(52) U.S. Cl. 710/307; 710/313

(57) ABSTRACT

The disclosure relates to a detachable signalling interconnect apparatus that provides connectivity between two or more components of a memory system in conjunction with different modes of operation of the components. The memory system comprises: a first socket to receive a first memory module; a second socket to receive a second memory module; a detachable signal-interconnect; and a memory controller coupled to the detachable signal-interconnect and configured to define a first mode of operation and a second mode of operation, wherein in the first mode of operation the detachable signal-interconnect is to couple the memory-controller to the first memory module and in the second mode of operation the detachable signal-interconnect is to couple the memory controller to the first memory module and the second memory module.

### TECHNICAL FIELD

This application relates generally to memory systems and more specifically, but not exclusively, to interconnect mechanisms for a memory system.

### BACKGROUND

Some types of memory systems are reconfigurable in that a user may change the amount or type of memory storage in the system. For example, a memory system may include a memory controller that is connected to several memory module sockets (e.g., connectors) via a memory bus. The memory controller may thus communicate with any memory modules that are installed in the sockets to control the operation of and provide access to the memory on these modules. Accordingly, a desired amount of memory storage may be provided in the memory system by adding the appropriate number and type of memory modules to the memory system.

### BRIEF DESCRIPTION OF THE DRAWINGS

Sample features, aspects and advantages of the disclosure will be described in the detailed description and appended claims that follow and the accompanying drawings, wherein:

FIG. 1, including FIGS. 1A and 1B, is a simplified diagram of an embodiment of a memory system that utilizes one or more detachable interconnects;

FIG. 2, including FIGS. 2A and 2B, is a simplified diagram of the memory system of FIG. 1 in a different configuration;

FIG. 3, including FIGS. 3A and 3B, is a simplified diagram of an embodiment of a memory system where a memory module includes one or more connectors for one or more detachable interconnects;

FIG. 4, including FIGS. 4A and 4B, is a simplified diagram of the memory system of FIG. 3 in a different configuration;

FIG. 5 is a simplified diagram of an embodiment of a memory system that implements a portion of a data bus as traces in a printed circuit board;

FIG. 6, including FIGS. 6A and 6B, is a simplified diagram of an embodiment of a memory system that utilizes a detachable interconnect to couple a memory module to another component;

FIG. 7, including FIGS. 7A and 7B, is a simplified diagram of an embodiment of a memory system where a memory module is directly coupled to a printed circuit board;

FIG. 8, including FIGS. 8A and 8B, is a simplified diagram of an embodiment of a memory system incorporating relatively rigid interconnects;

FIG. 9, including FIGS. 9A and 9B, is a simplified diagram of an embodiment of a surface-based coupling mechanism for a detachable interconnect;

FIG. 10, including FIGS. 10A and 10B, depicts simplified diagrams of embodiments of interposer coupling techniques for a detachable interconnect;

FIG. 11, including FIGS. 11A and 11B, depicts simplified diagrams of embodiments of detachable interconnects coupled to signal traces of printed circuit boards;

FIG. 12 is a simplified diagram of an embodiment of a coupling mechanism for a detachable interconnect where a connector is attached to a printed circuit board;

FIG. 13, including FIGS. 13A and 13B, is a simplified diagram of a memory module socket comprising an attachment mechanism and a passageway for a detachable interconnect;

FIG. 14 is a simplified diagram of an embodiment of an attachment mechanism for a detachable interconnect;

FIG. 15 is a simplified diagram of an embodiment of a memory system where a portion of a detachable interconnect is embedded in a printed circuit board;

FIG. 16 is a simplified diagram of an embodiment of an optical interconnect where a connector that receives the interconnect comprises optoelectronics;

FIG. 17 is a simplified diagram of an embodiment of an optical interconnect where a connector that is configured to receive the interconnect comprises optoelectronics;

FIG. 18 is a simplified block diagram of an embodiment of a reconfigurable memory system;

FIG. 19 is a flow chart of an embodiment of operations that may be performed by a reconfigurable memory system;

FIG. 20, including FIGS. 20A and 20B, is a simplified diagram of an embodiment of a memory system where a memory module is coupled to a detachable interconnect having multiple branches; and

FIG. 21, including FIGS. 21A and 21B, is a simplified diagram of the memory system of FIG. 20 where the original memory module has been removed and two other memory modules have been installed.

In accordance with common practice the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus or method. Finally, like reference numerals may be used to denote like features throughout the specification and figures.

### DETAILED DESCRIPTION

The description that follows sets forth one or more illustrative embodiments. It should be appreciated that the teachings herein may be embodied in a wide variety of forms, some of which may appear to be quite different from those of the disclosed embodiments. Consequently, the specific structural and functional details disclosed herein are merely representative and do not limit the scope of the invention. For example, based on the teachings herein one skilled in the art should appreciate that any of the disclosed structural and functional details may be incorporated in an embodiment independently of any other structural or functional details. Thus, an apparatus may be implemented or a method practiced using any number of the structural or functional details set forth or otherwise taught in any disclosed embodiment(s). Also, an apparatus may be implemented or a method practiced using other structural or functional details in addition to or other than the structural or functional details set forth in any disclosed embodiment(s).

The disclosure relates in some aspects to a detachable signal-interconnect apparatus that provides connectivity between two or more components in conjunction with different modes of operation of the components. For convenience, a signal-interconnect apparatus may be referred to herein simply as “an interconnect.” For illustration purposes, various aspects of several implementations of detachable interconnects will be discussed in the context of memory systems that employ a memory controller and one more memory storage devices (e.g., 1, 2, 3, 4, or more memory modules). It should be appreciated, however, that the teachings herein may be utilized in other types of systems including, for example, communication links for scaleable graphics architectures that may be implemented as graphics cards or in some other form. Thus, the teachings herein also may be employed to couple a central processing unit (“CPU”) to one or more other CPUs, to one or more graphics processing units (“GPUs”), or to some other components or components. Similarly, these concepts may be employed to couple a GPU to one or more other GPUs or to one or more other components.

Several embodiments of configurable width memory systems and various components that may be incorporated into a configurable width memory system are set forth below. In general, a configurable width memory system includes a memory controller, one or more sockets for one or more memory modules, one or more memory modules, and a detachable interconnect that effects point-to-point communication between the memory controller and the one or more memory modules.

The disclosure relates in some aspects to a detachable signal-interconnect that couples the memory controller to one or more of the memory modules, one or more memory devices on a memory module, one or more sockets, or some other component. In general, an interconnect serves to couple one or more signals from at least one component to at least one other component (e.g., between respective signal sources and sinks of these components). In some embodiments a detachable interconnect comprises flex tape or a flexible circuit (e.g., a flexible printed circuit). In some embodiments a flexible circuit comprises one or more flexible cables. In some embodiments a detachable interconnect comprises removable rigid connectors. In some embodiments a detachable interconnect comprises an optical cable. In practice, any of the above or other types of interconnects may comprise one or more parallel signal buses.

The disclosure relates in some aspects to a configurable width memory system that provides point-to-point connectivity between a memory controller and each memory module in the memory system. Advantageously, the detachable interconnect apparatus may be configured to provide such point-to-point connectivity irrespective of whether the memory system is partially or fully populated with memory modules.

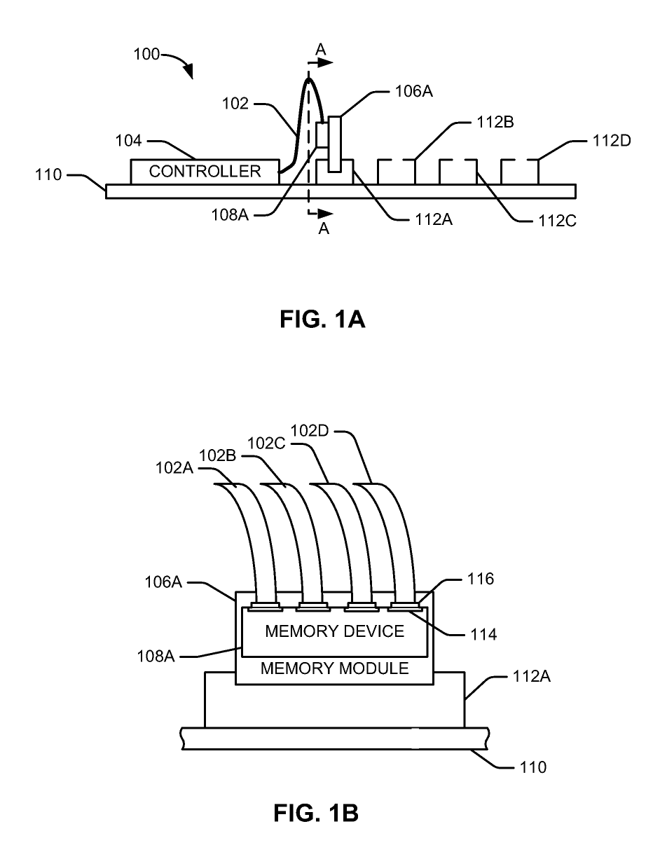

These and other aspects of the disclosure will be discussed in conjunction with FIGS. 1-21. In general, these figures are drawn in a simplified manner to emphasize certain aspects of the illustrated components.

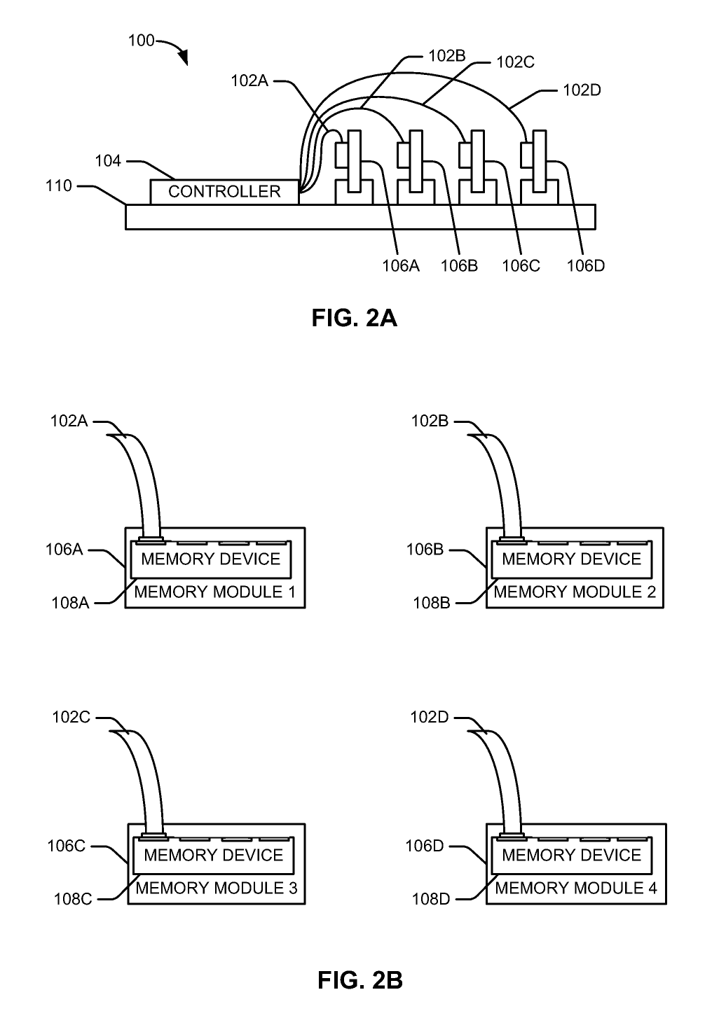

FIGS. 1 and 2 illustrate a memory system 100 where a detachable interconnect apparatus in the form of a flexible circuit assembly 102 is configured to connect a data bus interface of a memory controller 104 in a point-to-point manner to one memory module 106A (FIG. 1) or several memory modules 106A-106D (FIG. 2). In this example, the interconnect 102 comprises four branches 102A-102D. In addition, each of the memory modules 106A-106D includes a memory device 108A-108D, respectively. The memory controller 104 may be connected to a printed circuit board 110 via a conventional technique such as a ball grid array.

A series of sockets 112A-112D for the memory modules 106A-106D, respectively, also are connected to the printed circuit board 110. The sockets 112A-112D may couple power and ground to the memory modules 106A-106D and may, in some embodiments, route other signals (e.g., address and control signals) between the printed circuit board 110 and the memory modules 106A-106D, respectively. To this end, each of the memory modules 106A-106D includes another set of electrical contacts (not shown) that is configured to couple with a set of contacts (not shown) of an associated socket 112A-112D.

Also, as will be discussed in more detail below, in some embodiments the memory modules 106A-106D may include a set of contacts to provide signal connectivity via the sockets 112A-112D to a portion of the data bus. In these cases, the sockets may include additional signal paths (e.g., high-speed pins) for routing data signals between the printed circuit board and the memory modules. Such a configuration may be employed, for example, in conjunction with the first memory module that installed in the memory system (e.g., in the socket that is closest to the memory controller).

As will be discussed in more detail below, various connection mechanisms may be employed to detachably interconnect portions of a data bus between a memory controller, and components disposed remote from the controller such as one or more memory modules, memory devices, sockets, or other components. For example, an interconnect may be coupled to a component via a connector assembly or may be permanently coupled to the component. As an example of the latter scenario, an end portion of the interconnect may be fastened to, soldered to, or integrated within the component. FIG. 1B illustrates that the memory device 108A may include a connector (e.g., connector 114) that is complementary to a connector (e.g., connector 116) of each of the interconnect branches 102A-102D. Thus, in this example, each interconnect branch 102A-102D may be coupled to or decoupled from one of the connectors of the memory device 108A as needed. To reduce the complexity of FIG. 1, a single memory device 108A is depicted on the memory module 106A. It should be appreciated, however, that a given memory module may include one or more memory devices. In addition, in some embodiments each of these memory devices may include one or more connectors.

FIGS. 1A and 1B depict a first mode or configuration of the memory system 100 where each branch 102A-102D of the interconnect 102 is routed to the memory module 106A. In the side view of FIG. 1A the individual branches 102A-102D that make up the interconnect 102 are lined up one behind the other and, hence, are not clearly shown in this view.

FIG. 1B is a simplified representation of the memory module 106A from the perspective of the view A-A of FIG. 1A. Here, it may be observed that each branch 102A-102D of the interconnect 102 is coupled to one of the connectors (e.g., connector 114) of the memory module 106A.

The different interconnect branches 102A-102D may carry different portions of a memory data bus and associated data bus control signals (e.g., strobe, mask, and write enable signals) of the controller 104. For example, in an embodiment where the controller 104 supports a data bus with a width of 128 signals, each of the branches may carry one fourth of the data bus signals and associated control signals. Thus, in the configuration of FIGS. 1A and 1B the entire data bus is provided to the module 106A via the branches 102A-102D. Advantageously, through the use of the interconnect 102 in the first mode described above, all of the signals of the data bus may be routed between the controller 104 and the module 106A in a point-to-point configuration.

FIGS. 2A and 2B depict a second mode or configuration of the memory system 100 where each branch 102A-102D of the interconnect 102 is routed to a different one of the memory modules 106A-106D. Specifically, branch 102B is now coupled to memory device 108B, branch 102C is now coupled to memory device 108C, and branch 102D is now coupled to memory device 108D. Again, it should be appreciated that through the use of the interconnect 102 in the second mode, the signals of the data bus may be routed from the controller 104 directly to each of the modules 106A-106D in a point-to-point configuration.

FIGS. 1 and 2 thus illustrate that the system 100 may be easily reconfigured to increase the amount of available memory storage from that of one module (FIG. 1A) to multiple modules (FIG. 2A). Specifically, additional memory modules 106 may be installed in the system and one or more of the branches 102A-102D moved from a previously installed memory module 106 to each newly installed memory module 106. Moreover, point-to-point connectivity may be provided for every configuration as described above.

To accommodate the different interconnect configurations, the memory modules 106 may support different data bus widths. For example, for the configuration of FIG. 1B the memory device 108A may be configured in a first mode of operation to provide a data width of 128 bits. Then, for the configuration of FIG. 2B each of the memory devices 108A-108D may be configured in a second mode of operation to provide a data width of 32 bits. In conjunction with this reconfiguration, the effective depth (e.g., addressing range) of the memory device 108A may be increased by a comparable amount (e.g., quadrupled). In other words, in the configuration of FIG. 2B, the entire memory array of the memory device 106A is still available to the memory system 100. However, the memory array is accessible at a narrower bus width and a larger depth (e.g., a larger addressing range). To this end, the memory device 108A may include a multiplexer and demultiplexer or other suitable circuitry to reconfigure a data bus interface of its memory array, depending on the selected mode of operation (e.g., depending on the particular configuration of the memory system).

Alternatively, in other embodiments, reconfiguration of a memory system may be accompanied by replacement of any currently installed memory modules 106 with different memory modules that have a different (e.g., narrower) data width and a different (e.g., larger) memory depth. For example, a memory module 106A having a width of 128 bits and a depth of 16×M may be removed and two modules 106A and 106B added, each of which has a width of 64 bits and a depth of 32×M.

Other signals such as address and control signals may be routed between the controller 104 and a memory module 106 in various ways. For example, in some embodiments a portion or all of these other signals may be routed via trace interconnects in the printed circuit board 108 between the controller 104 and the memory module 106. Alternatively, in some embodiments a portion or all of these other signals may be routed via the interconnect 102. In some embodiments power and ground busses may be routed via the interconnect 102.

It should be appreciated that a detachable interconnect, such as a flexible circuit assembly, may be configured in a variety of ways in conjunction with the teachings herein. For example, in some embodiments the interconnect may consist of multiple circuits (e.g., cables, flex tape, etc.). In this case the controller will provide an appropriate interconnect (e.g., a connector or pads) for each circuit. In other embodiments a single interconnect may include several interconnect branches. For example, the interconnect may be a unitary assembly on one end that splits at some point along the assembly to form interconnect branches that may be connected to one or more memory modules. In this case the controller will provide an appropriate interconnect interface (e.g., a connector or a set of contacts) for the controller side of the interconnect.

A flexible circuit or other form of detachable interconnect may be constructed in various ways and of various materials to achieve a desired level of performance (e.g., signal rate, crosstalk, and so on). For example, in some embodiments the interconnect 102 may comprise a controlled impedance circuit and/or a low loss circuit. In some embodiments the interconnect 102 may comprise a high density circuit. Here, the interconnect 102 may be constructed in a manner that facilitates the transmission of a large number (e.g., on the order of one hundred or more) of high speed signals. The interconnect 102 also may be constructed in a manner that results in a relatively small amount of crosstalk between neighboring signals on the interconnect 102. To accomplish the above, the interconnect 102 may comprise a ribbon-type circuit that is fabricated using flex-circuit technology. Such an interconnect may employ, for example, a single layer or multilayer construction, microstrip line, strip-line or co-planar strip technology, one or more ground layers, and appropriate dielectric materials. Here, various types of dielectric materials may be employed depending on the cost/performance of a given application. Such dielectric materials may comprise, for example, FR-4, polyimide, liquid crystal polymer, a polyester-based dielectric, or some other suitable material. In some embodiments the interconnect may be adapted to carry differential signals. Here, each pair of conductors for the differential signals may be separated by one or more ground conductors. Through the use of such techniques reliable data signaling may be provided at rates on the order of 6 Gsymbols/s or more and, with more careful channel design (e.g., including the selection of appropriate materials), at signaling rates on the order of 10-30 Gsymbols/s or more.

A point-to-point detachable interconnect system such as the one described in FIGS. 1 and 2 may provide several advantages over conventional bussed interconnect systems. For example, a point-to-point configuration may advantageously enable signal transmitters and receivers to be located at ends of transmission lines for optimum configuration of termination circuitry. Also, no driver handoff between devices may be required which in turn, may ease device driver output matching requirements, improve efficiency, and simplify device simulation, characterization, and system level validation. In addition, transmitter pre-emphasis equalization circuitry may be simplified, because inter-symbol interference compensation may be provided for only a single receive node. Shorter signal lines also may be provided thereby allowing reduced signal attenuation, reduced flight time, simplified delay matching, and fewer impedance discontinuities. Furthermore, the memory controller may integrate clock controller calibration circuitry, providing opportunities for system-level cost reduction.

Moreover, additional benefits may be provided through the use of one or more detachable interconnects as taught herein. For example, point-to-point connectivity may be provided for fully populated module configurations without undesirable stubs or unused signal paths disposed between module sockets.

Also, in some embodiments, high quality materials and routing techniques may be used for the busses for the higher speed signals in the system (e.g., using a detachable interconnect such as a flexible circuit) while more cost effective materials and routing techniques may be used for the remaining busses in the system. For example, the remaining buses may be implemented using a printed circuit board constructed of conventional FR-4 dielectric or using other suitable techniques and materials. Thus, impedance variations (which also may cause undesirable signal reflections) that may otherwise be present on relatively low-cost printed circuit boards (e.g., a motherboard or a module) may be reduced thereby facilitating the use of higher speed signals.

Through the use of a detachable interconnect as taught herein, a significant improvement may be realized in signal quality between the controller and each module. For example, direct signal paths may be provided between the controller and all of the modules. Moreover, the signals may have less noise (e.g., due to fewer discontinuities and less crosstalk). In addition, higher frequency signals may be subjected to less attenuation. Furthermore, the electrical length for all of the signal paths may be designed to be substantially the same irrespective of the number of modules in the system, thereby enabling even further optimization of the memory bus.

With the above overview in mind, additional details of other aspects of the disclosure that may be employed in a configurable width memory system will now be treated. For convenience certain aspects will be discussed in conjunction with certain embodiments. It should be appreciated, however, that such aspects may be incorporated into another embodiment or a combination of embodiments.

In a similar manner as in FIGS. 1 and 2, FIGS. 3 and 4 illustrate a memory system 300 where a detachable interconnect apparatus takes the form of a flexible circuit assembly 302 that is configured to connect a memory controller 304 with one or more memory modules 306A and 306B. The interconnect 302 is configured to connect to connectors on the memory module 306A or to connectors on the memory modules 306A and 306B. For example, each branch 302A and 302B of the interconnect 302 may include a respective connector 310A and 310B that is configured to connect to a connector 308A on the memory module 306A or a connector 308B on the memory module 306B.

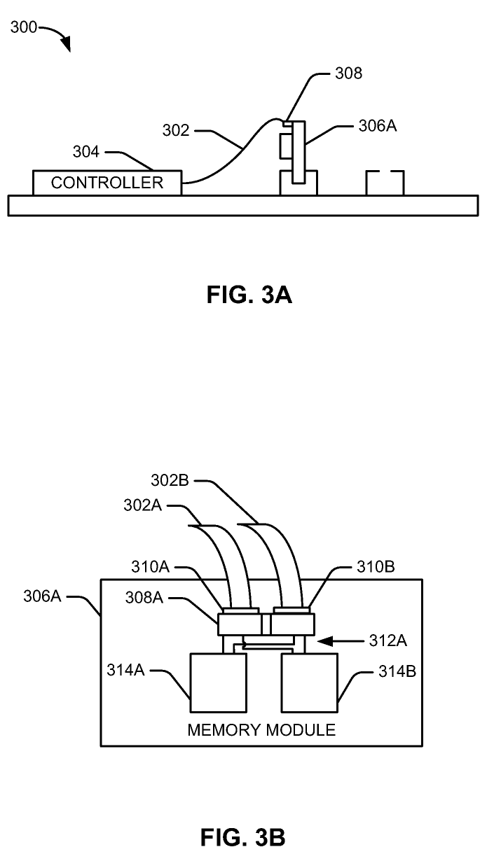

In the configuration of FIG. 3 (e.g., a first mode of operation) the interconnect branches 302A and 302B are connected to a left-side portion and a right-side portion, respectively, of the connector 308A. In this case a first portion of the data bus from the controller 304 is coupled to the memory module 306A via the interconnect branch 302A and a second portion of the data bus from the controller 304 is coupled to the memory module 306A via the interconnect branch 302B.

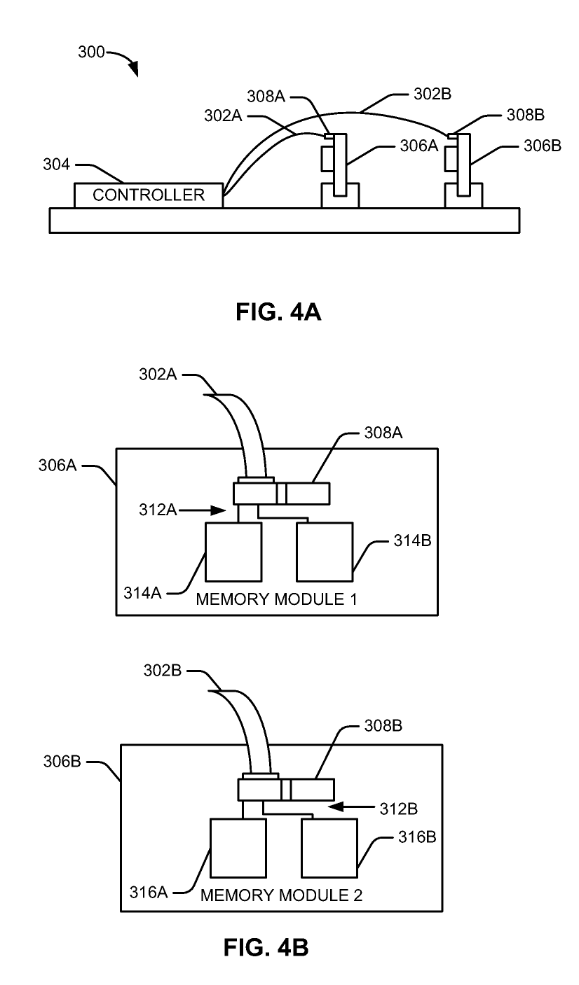

In the configuration of FIG. 4 (e.g., a second mode of operation) the branch 302A is connected to the left-side portion of the connector 308A and the branch 302B is connected to the left-side portion of the connector 308B. In this case a first portion of the data bus from the controller 304 is coupled to the memory module 306A via the interconnect branch 302A and a second portion of the data bus from the controller 304 is coupled to the memory module 306B via the interconnect branch 302B.

As in FIGS. 1 and 2, the memory system of FIG. 3 may thus be reconfigured by simply installing the memory module 302B and moving the interconnect branch 302B from the memory module 306A to the memory module 306B. In addition, the operations of the system 300 in the various configurations (e.g., first and second modes) also may be similar to the operations described above in conjunction with FIGS. 1 and 2.

FIGS. 3 and 4 also illustrate an embodiment where each memory module 306 includes two memory devices. It should be appreciated that in other embodiments a given memory module may include more than two memory devices.

Each memory module includes several sets of conductors 312 between its connector and memory devices. To reduce the complexity of FIGS. 3B and 4B each set of conductors 312 is simply depicted as a single line. For example, in FIG. 3B memory module 306A includes four sets of conductors 312A. These conductor sets may be implemented as traces in a printed circuit board of a memory module 306, as discrete wires, or in some other suitable manner.

In some embodiments a different subset of the signals associated with each portion of a connector may be coupled to different memory devices on a given memory module. For example, in FIG. 4B one conductor set of the conductor sets 312A may couple half of the signals from the branch interconnect 302A to a memory device 314A and another conductor set may couple the other half of the signals from the branch interconnect 302A to a memory device 314B. For illustration purposes, FIG. 4B only illustrates the portions of the conductor sets that may be used when the interconnect branches 302 are connected to the left-side portions of the connectors 308. It should be appreciated, however, that the memory modules of FIG. 4B also include conductor sets that couple the right-side portions of the connectors 308 with the memory devices. Through the use of the above wiring scheme, all of the memory devices of a given memory module may be used to store data irrespective of whether the interconnect branches 302 are attached to one or both portions of a connector 308.

It should be appreciated that the connectors may be configured in a variety of ways in conjunction with the teachings herein. For example, in some embodiments a given module (or any other component) may employ multiple connectors (e.g., as depicted in FIG. 1B) to connect to different interconnect branches or interconnects. In other embodiments a single connector may be employed whereby different interconnect branches or interconnects may be connected to different portions of the connector (e.g., as depicted in FIG. 3B).

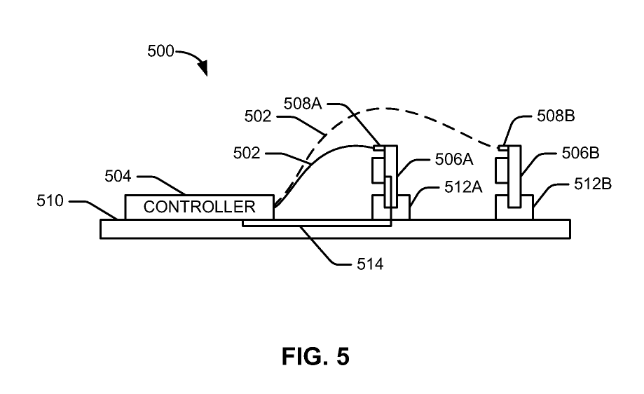

FIG. 5 illustrates an embodiment of a memory system 500 where a first portion of the signals previously described as being routed via a detachable interconnect apparatus (e.g., a flexible circuit) may instead be routed via a rigid interconnect such as a printed circuit board (for example, a motherboard). Similar to the system 300 of FIG. 4, the system includes a controller 504, memory modules 506A and 506B, a printed circuit board 510, a socket 512B, and, optionally, a socket 512A. In this case, however, a portion of the data signals of the controller 504 (e.g., signals corresponding to the signals carried by the interconnect branch 302A in FIG. 4) may be coupled to the memory module 506A in a point-to-point manner via a set of traces 514 in and/or on the printed circuit board 510. A detachable interconnect such as a flexible circuit assembly 502 may then be used to couple the remaining portion of the data signals of the controller 504 to one of the memory modules 506. To this end, the modules 506 may include connectors 508 (e.g., similar to the connectors 308 of FIG. 4).

The system 500 may be reconfigurable in a similar manner as the system 300. For example, in one configuration (e.g., a first mode of operation) the interconnect 502 is coupled in a point-to-point manner to the memory module 506A (as represented by the solid line). In this mode, the entire data bus width is interconnected between the controller 504 and the module 506A. In another configuration (e.g., a second mode of operation) the interconnect 502 is coupled in a point-to-point manner to the memory module 506B (as represented by the dashed line). Thus, in this mode, half the data bus width is directed to the first module 506A, while the other half is coupled to the second module 506B.

The embodiment of FIG. 5 may thus provide some of the advantages of other embodiments herein in addition to other potential advantages. For example, system cost may be reduced due to the elimination of a portion of the detachable interconnect. For example, in some embodiments a portion of the signals are routed directly via printed circuit board traces from a memory controller to a default first memory module. The rest of the signals may be routed through one or more reconfigurable interconnects to the default memory module. In such cases, a memory system that initially only includes the default memory module may be shipped without any interconnect, although it will operate with half the data bus width. This system may still be upgradeable provided an appropriate interface (e.g., switch/latch attachment point) for a reconfigurable interconnect exists. In addition, some embodiments may not employ the socket 512A. For example, the memory module 506A may be directly attached to the printed circuit board 510 (e.g., via a ball grid array) in cases where it is unlikely that the module 506A would be upgraded. Moreover, in some embodiments the set of traces 514 may be routed to a memory module 506 that is relatively close to the controller 504. In this case, trace width or routing constraints may be relaxed to some extent.

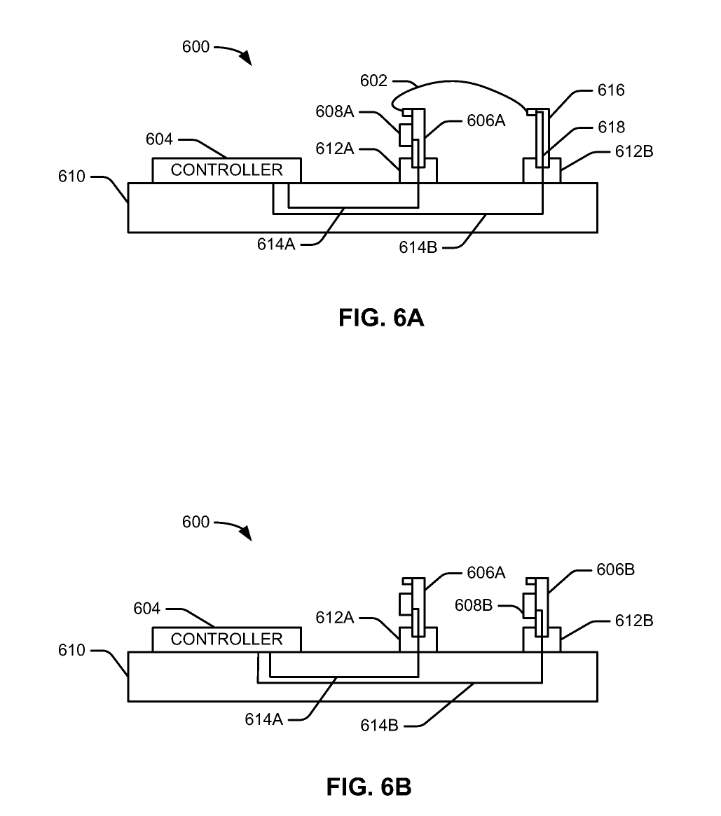

FIG. 6 illustrates another embodiment of a memory system 600 where a detachable interconnect apparatus 602 couples a memory module (or a memory device) to another component. Here, the detachable interconnect 602 is used to optionally couple a portion of a data bus to a memory module 606A in a first mode of operation as shown in FIG. 6A. In a similar manner as discussed above in conjunction with FIG. 5, in a second mode of operation as shown in FIG. 6B the memory system 600 may be reconfigured to include memory modules 606A and 606B. Again, the memory modules 606A and 606B include memory devices 608A and 608B, respectively, and may be attached to a printed circuit board 610 via attachment mechanisms 612A and 612B (e.g., sockets).

The printed circuit board 610 includes a first set of traces 614A for coupling a first portion of the data bus from the controller 604 to, for example, the socket 612A. The set of traces 614A may carry signals that are similar to, for example, the signals carried by the set of traces 514 of FIG. 5. Thus, in any configuration of the memory system 600, a first portion of the data bus may be coupled in a point-to-point manner to the memory module 606A.

The printed circuit board 610 also includes a second set of traces 614B for coupling a second portion of the data bus from the controller 604 to, for example, the socket 612B. The set of traces 614B may carry signals that are similar to, for example, the signals carried by the detachable interconnect 502 of FIG. 5.

In the first mode of operation as shown in FIG. 6A a continuity module 616 is inserted into the socket 612B. In addition, the detachable interconnect (e.g., a flexible circuit assembly) 602 is coupled between the continuity module 616 and the memory module 606A (e.g., via connectors or some other suitable mechanism). The continuity module 616 includes a set of conductors 618 that couple the second set of traces 614B to corresponding signal paths of detachable interconnect 602. In this way, the second portion of the data bus is coupled in a point-to-point manner between the controller 604 and the memory module 606A in the first mode of operation.

In the second mode of operation as shown in FIG. 6B the detachable interconnect 602 is disconnected from the memory module 606A and the continuity module 616 is removed from the socket 612B and replaced with the memory module 606B. Thus, in this case the second set of signals is not coupled to memory module 606A, but is instead coupled in a point-to-point manner to the memory module 606B. Consequently, in each of the configurations of the memory system 600 mentioned above, the data bus is coupled in a point-to-point manner to one or more memory modules.

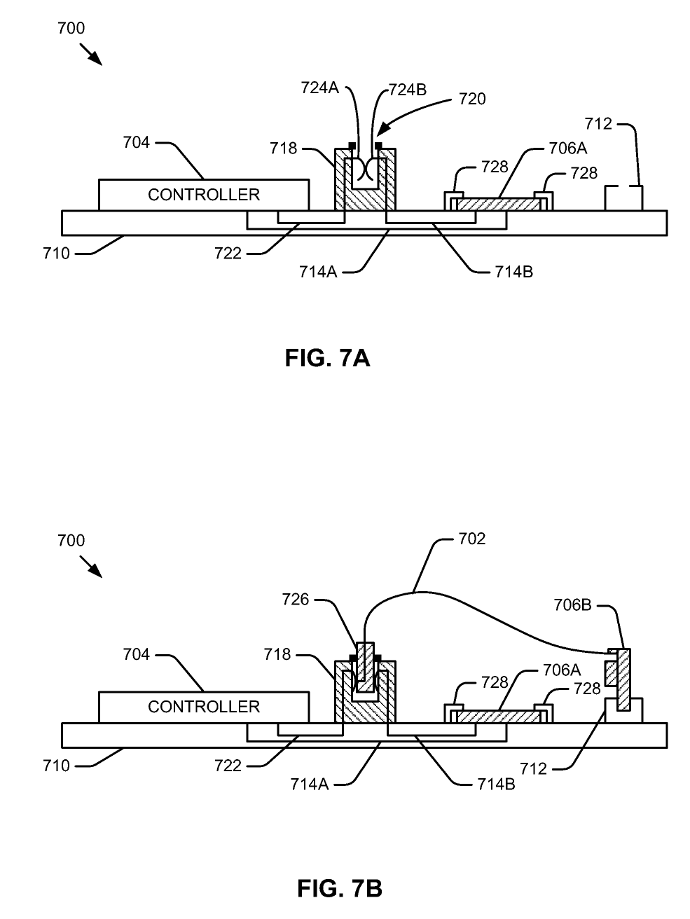

As mentioned above, in some embodiments a memory module may not be releasably coupled to the printed circuit board (e.g., via a releasable socket). For example, FIG. 7 illustrates an embodiment of a memory system 700 where a memory module 706A is directly coupled (e.g., attached) to a printed circuit board 710.

The printed circuit board 710 includes a first set of traces 714A for coupling a first portion of the data bus from a memory controller 704 to the memory module 706A. The set of traces 714A may carry signals that are similar to, for example, the signals carried by the set of traces 514 of FIG. 5. Thus, in any configuration of the memory system 700, a first portion of the data bus may be coupled in a point-to-point manner to the memory module 706A.

The printed circuit board 710 also includes a second set of traces 714B that may couple a second portion of the data bus from the controller 704 to the memory module 706A. For example, a socket or some other suitable component (hereafter referred to for convenience as “socket 718”) next to the memory controller 704 may include a connector 720 that optionally couples the second set of traces 714B with signal paths 722 that are coupled to an interface of the memory controller 704 for the second portion of the data bus. Thus, when coupled together, the set of traces 714B and the signal paths 722 may carry signals that are similar to the signals carried by the detachable interconnect 502 of FIG. 5.

In a first mode of operation as shown in FIG. 7A, the connector 720 couples the set of traces 714B and the signal paths 722. This coupling may be accomplished via, for example, opposing sets of releasable contacts 724A and 724B (shown in a simplified form). Accordingly, in this mode of operation, the second portion of the data bus is coupled in a point-to-point manner to the memory module 706A.

In a second mode of operation as shown in FIG. 7B the memory system 700 may be reconfigured to also include a memory module 706B (e.g., that is inserted into a socket 712). In this case, a detachable interconnect 702 may be used to couple the memory module 706B to the connector 720. To this end, the detachable interconnect 702 may include a connector 726 that is adapted to be inserted into the socket 718, thereby electrically coupling signal paths of the detachable interconnect 702 to the set of contacts 724A. Here, the insertion of the connector 726 into the socket 718 causes the opposing sets of releasable contacts 724A and 724B to disengage from one another (e.g., move apart). In this way, the second portion of the data bus (i.e., the signal paths 722) is decoupled from the memory module 706A and is instead coupled to the memory module 706B. Thus, in this mode of operation the second portion of the data bus is coupled in a point-to-point manner to the memory module 706B via the interconnect 702.

Various techniques (e.g., soldering and/or clamping) may be employed to couple or attach the memory module 706A to the printed circuit board 710. For example, in some embodiments the memory module 706A may comprise a ball grid array (not shown in FIG. 7) that is soldered to corresponding lands on the printed circuit board 710. In some embodiments the memory module 706A may comprise a set of lands and vias or other suitable conductive elements (not shown in FIG. 7) that line up with corresponding lands on the printed circuit board 710. In this case (and other cases as well) a mechanical attachment mechanism (e.g., a clamping device) 728 may be used to attach the memory module 706A to the printed circuit board 710.

In embodiments that utilize sets of traces to carry data bus signals (e.g., as discussed herein) a given memory module may be relatively close to the memory controller. In these cases, to some extent it may be possible to relax trace width constraints or routing constraints for the connections to such a module.

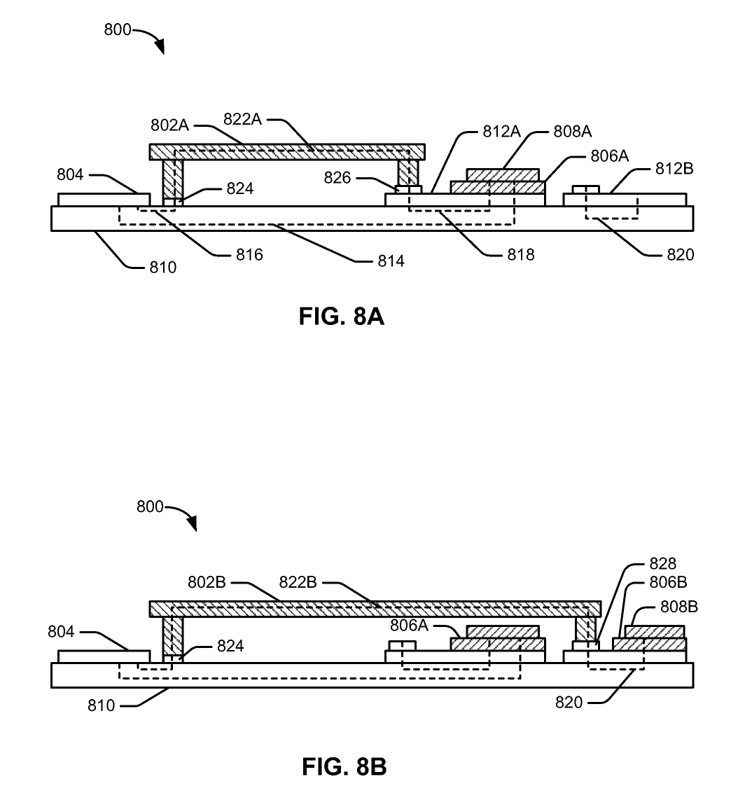

FIG. 8 illustrates a memory system 800 where a detachable interconnect apparatus takes the form of relatively rigid assemblies 802 that are configured to couple a memory controller 804 with various memory modules (e.g., modules 806A and 806B). The memory modules 806A and 806B include memory devices 808A and 808B, respectively, and may be attached to the printed circuit board 810 via attachment mechanisms 812A and 812B (e.g., sockets).

The printed circuit board 810 includes a first set of traces 814 for coupling a first portion of the data bus from the controller 804 to the first memory module 806A. The set of traces 814 may carry signals that are similar to, for example, the signals carried by the set of traces 514 of FIG. 5. Thus, in any configuration of the memory system 800, a first portion of the data bus may be coupled in a point-to-point manner to the memory module 806A.

The memory system 800 is reconfigured by swapping the assembly 802A of FIG. 8A with the assembly 802B of FIG. 8B, or vice versa. To this end, the printed circuit board 810 includes other sets of traces 816, 818, and 820 for coupling, in a point-to-point manner, a second portion of the data bus from the controller 804 to either the first memory module 806A or the second memory module 806B. These sets of traces may carry signals that are similar to, for example, the signals carried by the interconnect 502 of FIG. 5.

In the configuration of FIG. 8A (e.g., a first mode of operation) the assembly 802A couples the set of traces 816 to the memory module 806A. Specifically, the assembly 802A includes a set of conductors 822A that couple signals from the set of traces 816 to the set of traces 818. The set of traces 818 then couple these signals to the memory module 806A via the attachment mechanism 812A. Thus, the full data bus width is provided to the memory module 806A.

In the configuration of FIG. 8B (e.g., a second mode of operation) the assembly 802B couples the set of traces 816 to the memory module 806B. Here, the assembly 802B includes a set of conductors 822B that couple signals from the set of traces 816 to the set of traces 820. The set of traces 820, in turn, couple these signals to the memory module 806B via the attachment mechanism 812B. As a result, half the data bus is interconnected to the first module 806A, while the other half is coupled to the second module 806B.

The assemblies 802 may take various forms. For example, in some embodiments each assembly 802 may comprise a secondary printed circuit board (e.g., the horizontal sections of the assemblies 802 in FIG. 8) and associated connectors (e.g., the vertical sections of the assemblies 802). For example, both assemblies 802A and 802B may include a connector for connecting to a connector 824 of the printed circuit board 810 that provides connectivity to the set of traces 816. The assembly 802A also may include a connector for connecting to a connector 826 of the attachment mechanism 812A that provides connectivity to the set of traces 818. Similarly, the assembly 802B may include a connector for connecting to a connector 828 of the attachment mechanism 812B that provides connectivity to the set of traces 820.

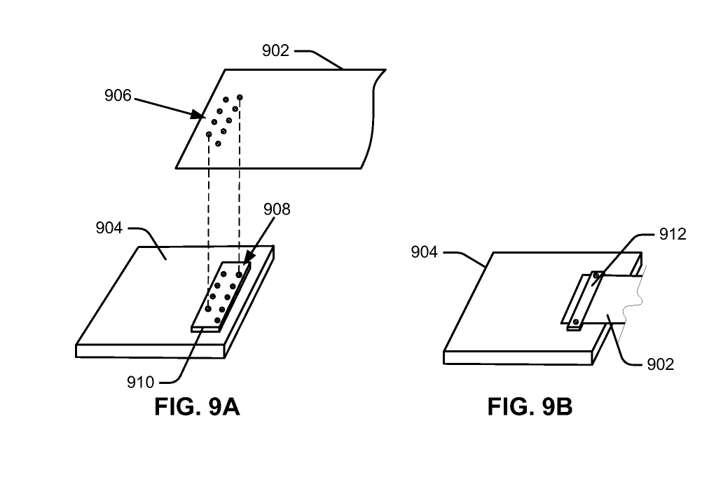

As mentioned above, a variety of different types of coupling techniques and mechanisms may be employed to connect a detachable interconnect such as a flexible circuit assembly to another component. Such a component may be, for example, an integrated circuit component such as a memory controller or a memory device or some other component such as a memory module, a socket, or a printed circuit board. In practice, an interconnect may be attached to the top, bottom, or sides of a component. Several specific examples of relatively permanent coupling techniques and mechanisms will now be described in conjunction with FIGS. 9-12.

FIG. 9A illustrates that in some embodiments an interconnect (e.g., a flexible circuit) 902 and a device 904 may include symmetrical sets of electrical contacts (e.g., pads, lands, or traces). For example, the interconnect 902 may be coupled to the device 904 by connecting a set of electrical contacts 906 of the interconnect 902 with a similar set of electrical contacts 908 of the device 904. That is, corresponding pairs of contacts from the interconnect 902 and the device 904 are electrically coupled and, at least to some degree, mechanically coupled. In FIG. 9A two of these pairs of contacts are indicated by the vertical dashed lines.

Various techniques may be employed to couple the pairs of contacts. For example, in some embodiments either of the fields 906 and 908 may comprise solder (e.g., solder balls) or some other suitable material that melts when heated to thereby couple corresponding pairs of contacts from the interconnect 902 and the device 904.

In some embodiments the coupling may employ the use of an anisotropic conductive film (“ACF”). For example, an ACF component 910 may be placed between the contact fields 906 and 908. Here, each contact of the contact fields may extend slightly from a surface of the interconnect 902 or the device 904. Upon application of heat (e.g., 180-200° C.) and mechanical pressure that forces the interconnect 902 and the device 904 together, conductive material in the ACF component 910 forms conductive paths between diametrically opposed pairs of contacts in the contact fields 906 and 908. In addition, the epoxy-based ACF component 910 will soften upon application of the heat. Once the ACF component 910 cools, it will bond to inner surfaces of the interconnect 902 and the device 904 forming a mechanical bond between these components.

Referring to FIG. 9B, in some embodiments a mechanical attachment mechanism 912 (e.g., a pressure mount mechanism) may be employed to further secure the interconnect 902 to the device 904. For example, the mechanical attachment mechanism 912 may comprise a clamp, a clamshell mechanism, or some other suitable mechanism to provide strain relief for the interconnect 902.

In practice, a set of electrical contacts such as the one described in FIG. 9 may be incorporated into a detachable interconnect and to any component with which the interconnect may connect. For example, a set of contacts may be incorporated into a surface of a interconnect, an integrated circuit (e.g., a memory controller, a memory device, and so on), a memory module, a printed circuit board, a socket, or some other system component. Also, it should be appreciated that a set of contacts may include contacts for unidirectional as well as bidirectional signals.

In some embodiments the device 904 also may include at least one other set of electrical contacts to provide signal connectivity to other components in a memory system. For example, a memory controller may include a set of contacts (e.g., on its bottom side) to provide signal connectivity to other devices on a motherboard. As discussed herein, a memory controller also may include one or more sets of contacts that provide signal connectivity to one or more memory modules. For example, these contacts may be associated with address signals, control signals, and a portion of the data bus. Similarly, a memory device may include one or more sets of contacts that provide signal connectivity to an associated memory module. Again, these contacts may be associated with address signals, control signals, and a portion of the data bus.

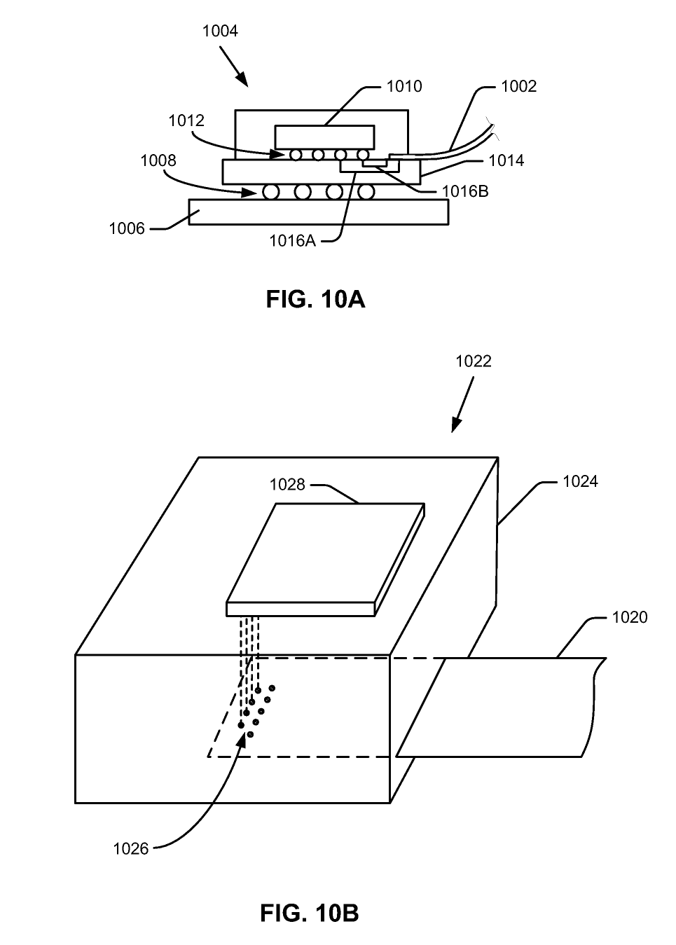

Referring to FIG. 10, in some embodiments an interposer technique may be employed to couple an interconnect (e.g., a flexible circuit) to another component. FIG. 10A illustrates an embodiment where an interconnect 1002 is incorporated in a device 1004. One or more sets of electrical contacts 1008 on the bottom of the device 1004 may be coupled to a printed circuit board 1006 or some other component via any suitable technique (e.g., via a set of solder balls on a ball grid array package) to provide signal connectivity to other components in a memory system. The device 1004 includes an integrated circuit die 1010 that is coupled (e.g., via electrical contacts 1012) to a substrate 1014. Here, the interconnect 1002 is “sandwiched” between the substrate 1014 and another component of the device 1004 to provide mechanical stability. In addition, sets of traces 1016 are provided in the substrate 1014 to connect conductors of the interconnect 1002 with a portion of the electrical contacts 1012 of the die 1010.

FIG. 10B illustrates a similar technique for coupling an interconnect (e.g., a flexible circuit 1020) to a device 1022. In this case, however, the interconnect 1020 is interposed within a substrate 1024 of the device 1022. As partially represented by the vertical dashed lines, a set of traces or some other type of conductive path couples conductors (e.g., electrical contacts 1026) of the interconnect 1020 with a portion of the electrical contacts (not shown) of an integrated circuit die 1028 of the device 1022.

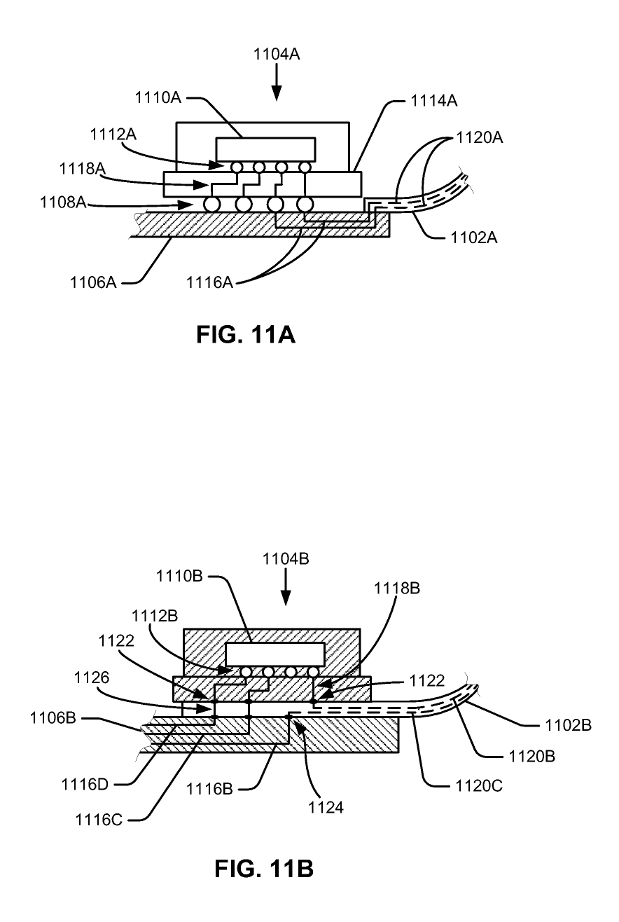

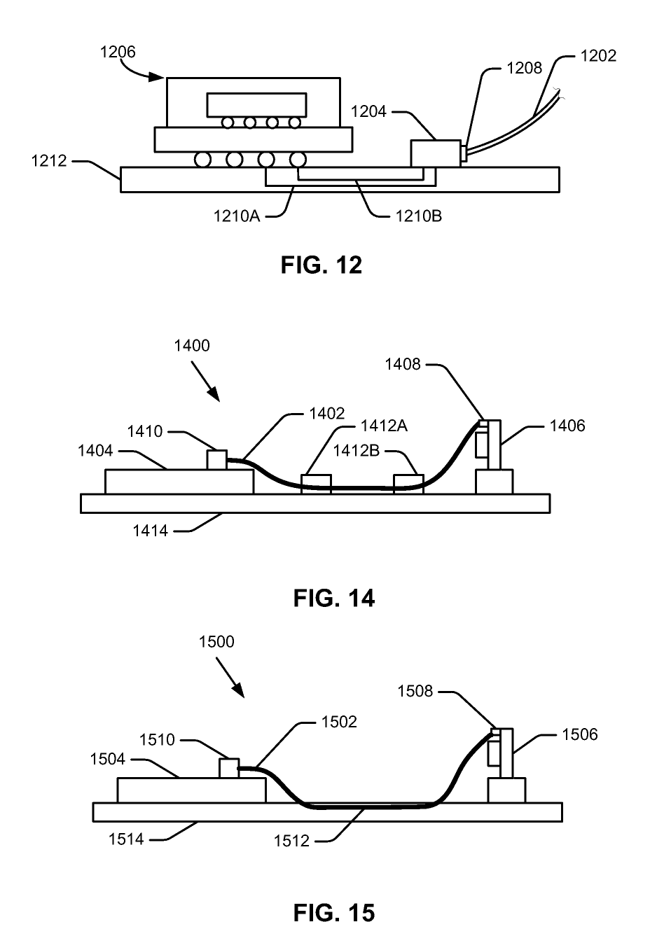

Referring to FIGS. 11 and 12, in some embodiments a detachable interconnect (e.g., a flexible circuit) may be coupled to a printed circuit board. Here, traces in the printed circuit board are configured to couple the conductors (e.g., electrical contacts) of the detachable interconnect with another component (e.g., an integrated circuit or a socket).

FIG. 11A illustrates an embodiment where a detachable interconnect 1102A is attached to a printed circuit board 1106A. In this case signal paths 1120A of the interconnect 1102A may be coupled to a component (e.g., an integrated circuit device 1104A or a socket) via a set of traces 1116A in the printed circuit board 1106A.

The interconnect 1102A may be coupled to the printed circuit board 1106A in a variety of ways. For example, in some embodiments the interconnect 1102A and the printed circuit board 1106A included complementary sets of electrical contacts (e.g., pad, lands, or traces) that may be soldered together. As discussed above, either of these fields may comprise solder (e.g., solder balls) that melts when heated or some other suitable material that couples corresponding pairs of contacts of the interconnect 1102A and the printed circuit board 1106A. In some embodiments the coupling may employ the use of an anisotropic conductive film (“ACF”), for example, as discussed above in conjunction with FIG. 9, or interposer, for example, as discussed above in conjunction with FIG. 10.

FIG. 11A illustrates an example where the component 1104A is an integrated circuit device. The device 1104A may thus include an integrated circuit die 1110A that is mounted on a substrate 1114A whereby a set of contacts 1112A of the die 1110A is coupled to a set of contacts 1108A (e.g., a ball grid array) of the device 1104A. Here, vias 1118A or some other type of conductive path may be provided in the substrate 1114A to couple the contacts 1108A and 1112A. Accordingly, in this example the set of traces 1116A connect to the contacts 1108A of the device 1104A to couple the conductors 1120A of the interconnect 1102A to the integrated circuit die 1110A.

FIG. 11B illustrates an embodiment where an end portion of a detachable interconnect 1102B is coupled between a printed circuit board 1106B and a component 1104B. In this case signal paths 1120B of the interconnect 1102B may be coupled to signals paths 1118B (e.g., coupled to a ball grid array 1122) of the component 1104B. The signal paths 1118B may, in turn, be coupled to contacts 1112B of a die 1110B. In addition, signal paths 1120C of the interconnect 1102B may be coupled to traces 1116B of the printed circuit board 1106B. To this end the interconnect 1102B may include contact points (e.g., solder bumps 1124) or some other suitable structure for coupling the signal paths 1120A and 1120B to the signal paths 1118B or the traces 1116B. In addition, the interconnect 1102B may include feed-through paths 1126 (e.g., through-holes) for transmitting power, ground, and other signals between traces 1106C and 1106D of the printed circuit board 1106B and a portion of the contacts 1122 of the component 1104B. Here, the feed-through paths 1126 may not be coupled to the signal paths 1120 of the interconnect 1102B.

FIG. 12 illustrates an embodiment where an interconnect 1202 is configured to couple with a connector 1204 that is attached to a printed circuit board 1212. The interconnect 1202 may thus include a connector 1208 that is complementary to the connector 1204. In this example, the conductors of the interconnect 1202 are coupled to a component 1206 (e.g., an integrated circuit device or a socket) via a set of traces 1210 in the printed circuit board 1212.

FIG. 12 illustrates an example where the component 1206 is an integrated circuit device. Accordingly, in this example the set of traces 1210 connect to contacts of the device 1206 to couple the conductors of the interconnect 1202 to an integrated circuit die of the device 1206.

It should be appreciated that the above techniques may be used to connect an interconnect to various types of devices. For example, the embodiments relating to attachment to an integrated circuit may involve a memory controller, a memory device, or some other type of device. The embodiments relating to an attachment to a printed circuit board may involve a system motherboard, a memory module, or some other type of board component. The embodiments relating to an attachment using a connector may involve an integrated circuit, a printed circuit board, a socket, or some other type of component.

The interconnect coupling techniques described herein may be performed at various stages of the manufacturing process. For example, in some embodiments an interconnect is attached to an integrated circuit device during the integrated circuit assembly process (e.g., in embodiments such as those shown in FIGS. 9 and 10). In some embodiments the interconnect may be attached to a given component when a printed circuit board or a memory module is manufactured. Here, the interconnect may be attached using a standard surface mount technique or some other suitable technique (e.g., in embodiments such as the one shown in FIG. 11).

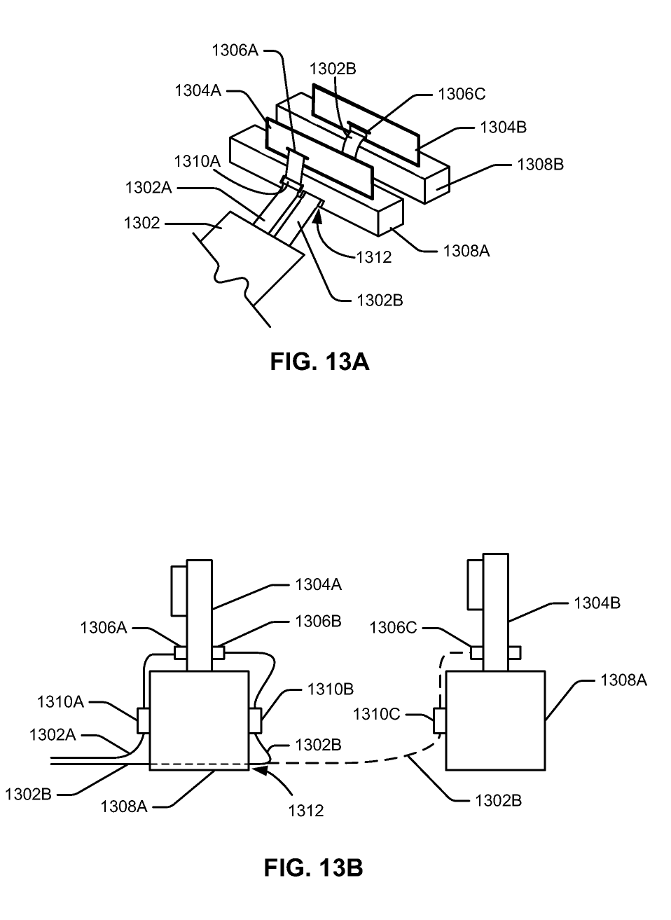

Referring to FIGS. 13 and 14, several examples of techniques for mounting a flexible interconnect in a memory system will be discussed. In general, these techniques may be employed to provide efficient routing of the flexible interconnect in a manner that does not form sharp bends in the flexible interconnect and that serves to reduce any undesirable movement of the flexible interconnect. FIG. 13 relates to techniques and mechanisms for mounting a flexible interconnect to a memory module. FIG. 14 relates to techniques and mechanisms for mounting a flexible interconnect to a printed circuit board.

FIG. 13A depicts a flexible interconnect 1302 having two branches 1302A and 1302B. The interconnect branch 1302A is routed to a connector 1306A on a first memory module 1304A. As discussed herein the memory module 1304A may be inserted into a socket 1308A on a printed circuit board.

To facilitate routing the interconnect branch 1302A to the memory module 1304A, the socket 1308A includes (or is attached to) a feed-through mechanism 1310A for the interconnect branch 1302A. That is, the interconnect branch 1302A may be passed through a hole or slot defined by the feed-through 1310A and thereby held in place to some degree.

The interconnect branch 1302B is routed to the memory module 1304A or to the memory module 1304B, depending on the configuration of the memory system. For example, in a first mode of operation the interconnect branch 1302B is routed to a connector 1306B on a back side of the memory module 1304A. This configuration of the interconnect branch 1302B is represented by the solid line in FIG. 13B. Here, the socket 1308A includes a passageway 1312 to facilitate routing the interconnect branch 1302B to the back side of the memory module 1304A. In addition, the socket 1308A includes (or is attached to) a feed-through 1310B for the interconnect branch 1302B. The feed-through 1310B may be similar to the feed-through 1310A discussed above.

In a second mode of operation the interconnect branch 1302B is routed to a connector 1306C of the memory module 1304B. This configuration of the interconnect branch 1302B is represented by the dashed line in FIG. 13B. Here, the interconnect branch 1302B is routed through the passageway 1312 to provide relatively easy access to the memory module 1304B. The socket 1308B includes (or is attached to) a feed-through 1310C for the interconnect branch 1302B. The feed-through 1310C may be similar to the feed-through 1310A discussed above.

FIG. 14 illustrates an embodiment of a memory system 1400 where one or more mechanical stays 1412 are used to fasten a flexible interconnect 1402 to a printed circuit board 1414. As discussed above, the interconnect 1402 couples signals between, for example, a connector 1410 of a memory controller 1404 and a connector 1408 of a memory module 1406. Here, the mechanical stays 1412 serve to hold the interconnect 1402 in place to, for example, avoid unwanted movement of the interconnect 1402 and/or to provide strain relief for the interconnect 1402.

It should be appreciated that an interconnect may be attached to a printed circuit board in a variety of other ways. For example, in some embodiments an adhesive such as epoxy may be used to adhere the interconnect to the printed circuit board.

Referring to FIG. 15, in some embodiments a portion 1512 of an interconnect (e.g., a flexible circuit 1502) may be embedded (e.g., encapsulated) in a printed circuit board stackup 1514. In FIG. 15 the interconnect 1502 couples signals between, for example, a connector 1510 of a memory controller 1504 and a connector 1508 of a memory module 1506. In this embodiment, however, only the end portions of the interconnect 1502 may be free to flex. Such a configuration may, for example, provide a desired level of stability, without adding additional components to the memory system 1500.

Alternatively, some embodiments may utilize a hybrid printed circuit board manufacturing process whereby different sections of the printed circuit board may utilize different dielectrics and/or different trace routing techniques. In such a case the interconnect is, in effect, incorporated into the designated section of the printed circuit board since the materials and characteristic of that section may be substantially the same as the materials and characteristic of a interconnect.

In general, an interconnect apparatus as taught herein may employ various types of signaling schemes. For example, an interconnect apparatus may employ electrical signals (e.g., transmitted via electrical conductors), optical signals (e.g., transmitted via optical fibers), or wireless signals such a radio frequency signals or infrared signals (e.g., transmitted via an appropriate medium such as air).

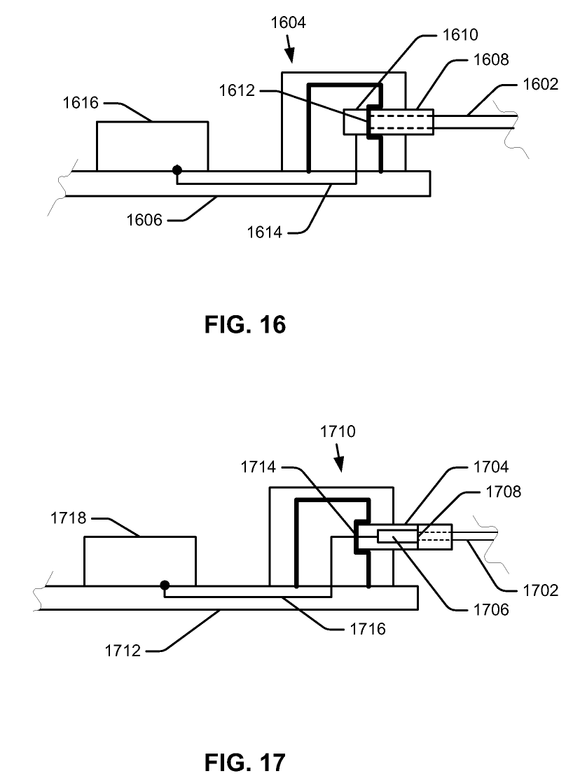

FIGS. 16 and 17 illustrate embodiments of interconnect systems that employ an optical interconnect (e.g., an optical cable assembly). Here, an optical interconnect may include a plurality of optical waveguides (e.g., optical fibers) for transmitting data bus and associated control signals in a similar manner as discussed above for the electrical conductor-based interconnect. In each figure the optical interconnect is configured to couple with a connector on a printed circuit board. A set of traces in the printed circuit board couple electrical signals between the connector and another component (e.g., a memory controller or a memory module). It should be appreciated that other connector configurations may be employed in other embodiments. For example, a connector including optoelectronics may be attached to another type of component such as a memory controller, a memory module, a memory device, or a socket.

The embodiment of FIG. 16 incorporates a passive optical interconnect (e.g., cable assembly) 1602 that connects to a connector 1604 on a printed circuit board 1606. Here, a connector portion 1608 on an end of the interconnect 1602 is aligned with optoelectronic component 1610 of the connector 1604 at an interface region 1612. The optoelectronic component 1610 may include optical detectors (e.g., photodetectors and associated transimpedance amplifiers) and optical drivers (e.g., light emitting diodes) to respectively receive optical signals from and transmit optical signals to the optical waveguides of the interconnect 1602. A set of traces 1614 in the printed circuit board 1606 couple the corresponding electrical signals between the connector 1604 and a component 1616. For example, signals generated by a component 1616 are coupled to the optoelectronic component 1610 via the set of traces 1614. The optoelectronic component 1610 then generates optical signals corresponding to the received electrical signals and directs these optical signals over one or more optical paths provided by the optical interconnect 1602. Conversely, the optoelectronic component 1610 generates electrical signals that correspond to the optical signals the optoelectronic component 1610 receives from the optical interconnect 1602. The set of traces 1614 then couple these electrical signals to the component 1616 for processing.

FIG. 17 depicts an embodiment where optoelectronics may be incorporated into an optical interconnect (e.g., cable assembly) 1702. For example, a connector portion 1704 on an end of the interconnect 1702 includes an optoelectronic component 1706. The optoelectronic component 1706 is aligned at an interface region 1708 with an end of the optical waveguide of the interconnect 1702. In a similar manner as discussed above, the optoelectronic component 1706 may include optical detectors and optical drivers to respectively receive optical signals from and transmit optical signals to the optical waveguide of the interconnect 1702.

The connector 1704 is coupled to a connector 1710 on a printed circuit board 1712. In this case, the connectors 1704 and 1710 includes appropriate contact mechanisms at an interface region 1714 to receive electrical signals from and provide electrical signals to the optoelectronic component 1706. In addition, the connector 1710 may couple a power bus from the printed circuit board 1712 to the connector 1704 to provide power for the optoelectronic component 1706. Also, in a similar manner as discussed above, a set of traces 1716 in the printed circuit board 1712 couple the corresponding electrical signals between the connector 1710 and a component 1718.

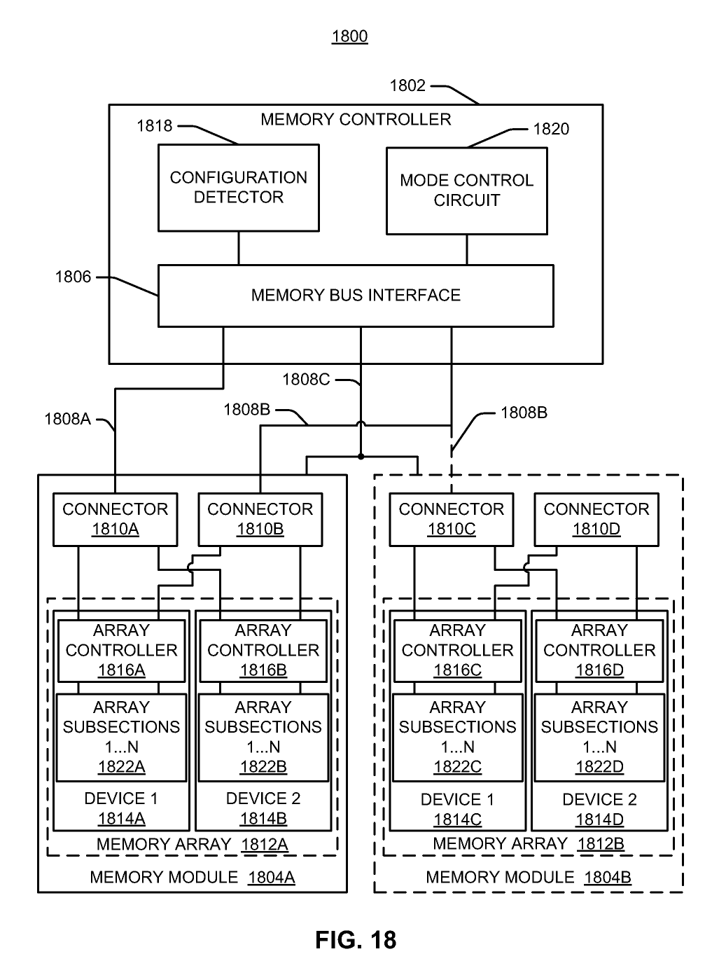

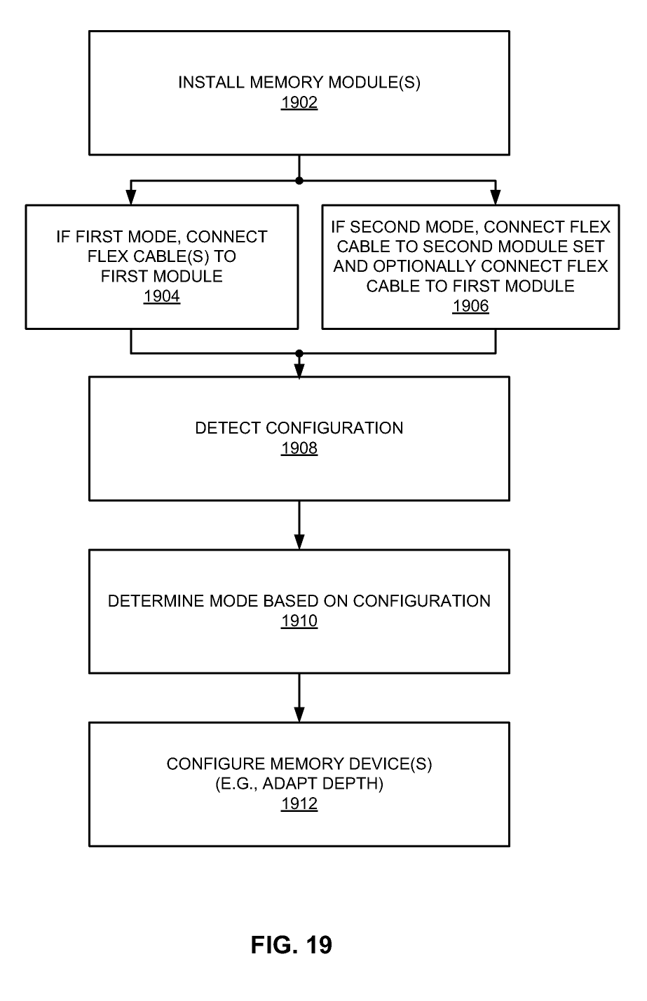

With reference to FIGS. 18 and 19, an overview will be provided of several sample functional components and operations of an embodiment of a memory system. In particular, the discussion that follows relates to operations associated with supporting reconfiguration of the memory system.

FIG. 18 illustrates in a simplified manner a memory system 1800 including a memory controller 1802 and, in a first mode of operation, a memory module 1804A and, in a second mode of operation, two memory modules 1804A and 1804B. Here, the dashed lines defining the memory module 1804B represent that this module is optional. The memory controller 1802 includes a memory bus interface 1806 that transmits signals to and receives signals from one or both of the memory modules 1804 via a memory bus 1808. To reduce the complexity of FIG. 18, the memory bus 1808 is represented by three lines 1808A, 1808B, and 1808C. It should be appreciated that in a typical implementation, the memory bus 1808 may include a relatively large number of signal lines (e.g., on the order of 100 or more). The memory controller 1802 also has a bus interface (not shown) that communicates with other components in a computing system. This bus interface enables these other components to read data from and write data to the memory modules 1804.

The memory modules 1804 typically comprise some form of read/write memory. For example, such memory may comprise RAM, DRAM, flash, SRAM, or some other type of memory. Also, in some implementations a memory module may comprise a ROM device.

One portion of the memory bus 1808 comprises an address and control bus 1808C that defines the subset of the memory space of the memory modules 1804 that is being accessed at a given time. In a typical implementation all of the signals of the address and control bus 1808C are routed to each memory module 1804.

FIG. 18 illustrates an embodiment where a data bus portion of the memory bus 1808 is coupled between the memory controller 1802 and one or both of the memory modules 1804A and 1804B in a point-to-point manner. As represented by the lines 1808A and 1808B, this data bus is split in half. For example, as discussed above, a first portion of the data bus (e.g., data bits 0-31) and associated data bus control signals (e.g., strobe, mask, and write enable signals) may be coupled to a first interconnect branch (e.g., data bus signals 1808A). In addition, a second portion of the data bus (e.g., data bits 32-63) and associated data bus control signals (e.g., strobe, mask, and write enable signals) may be coupled to a second interconnect branch (e.g., data bus signals 1808B). As represented by the solid line 1808B, in a first mode of operation the second interconnect branch 1808B is only coupled to the first memory module 1804A. Conversely, as represented by the dashed line 1808B, in a second mode of operation the second interconnect branch 1808B is only coupled to the second memory module 1804B.

Each memory module 1804 may include one or more connectors 1810 or some other connection mechanism for coupling with one or more interconnect branches. For example, as represented by the line 1808A, in the first mode of operation the first interconnect branch 1808A is coupled in a point-to-point manner between the memory controller 1802 and a connector 1810A of the first memory module 1804A. In addition, as represented by the solid line 1808B, in the first mode of operation the second interconnect branch 1808B is coupled in a point-to-point manner between the memory controller 1802 and a connector 1810B of the first memory module 1804A.

Conversely, as represented by the dashed line 1808B, in the second mode of operation the second interconnect branch 1808B is coupled in a point-to-point manner between the memory controller 1802 and a connector 1810C of the second memory module 1804B. Thus, in the second mode of operation the second interconnect branch 1808B is not connected to the connector 1810B.

As discussed above in conjunction with FIG. 4, all of the signal lines associated with each connector (e.g., connectors 1810A and 1810B) in a given module (e.g., module 1804A) may be coupled to a memory array 1812 for that module. In this way, the entirety of the memory array 1812 may be utilized irrespective of whether one or both of the interconnect branches are connected to that module's connectors.

Each memory array 1812 comprises one or more storage devices 1814 (e.g., a DRAM chip). For example, the memory array 1812A includes two storage devices 1814A and 1814B. Other embodiments may employ a different number of storage devices. Also, the memory arrays 1812 of FIG. 18 are depicted using dashed lines to represent that in some implementations the memory array may simply comprise the memory devices 1814 (e.g., no other components are employed to provide the memory array 1812).

Each module 1804 also includes a data bus interface (e.g., comprising one or more array controllers 1816) or other similar functionality that controls how the memory devices 1814 are accessed during different modes of operation of the memory system 1800. Such an array controller may include, for example, appropriate multiplexing and demultiplexing circuitry to selectively couple portions of the data bus to a plurality of subsections 1822 (e.g., memory array subsections 1 . . . N) of the data memory of each memory device 1814. As shown in FIG. 18, in some embodiments some or all of the functionality of each array controller 1816 may be implemented within each memory device 1814.

As mentioned above, in the first mode of operation the first interconnect 1808A associated with a first data bus portion is inserted into the connector 1810A and the second interconnect 1808B associated with a second data bus portion is inserted into the connector 1810B. In this case, the array controller 1816A couples the signals of the first interconnect 1808A and the second interconnect 1808B to the plurality of memory array subsections 1822A. Similarly, the array controller 1816B couples the signals of the first interconnect 1808A and the second interconnect 1808B to the plurality of memory array subsections 1822B. It should be appreciated that in other implementations these components may be coupled in other ways.

Also as mentioned above, in the second mode of operation the second interconnect 1808B is moved to the connector 1810C of the module 1804B. In this case, the array controller 1816A may couple the signals of the first interconnect 1808A to the memory array subsections 1822A. Note that here, as compared to the first mode of operation, only half as many subsections may be associated with the data bus for a given memory access. In this case, the other half of the subsections are coupled to the data bus during a memory access associated with different address. The array controller 1816B will provide similar functionality to couple the interconnect 1808A to the array subsections 1822B. In addition, the array controllers 1816C and 1816D will provide similar functionality to couple the interconnect 1808B to the array subsections 1822C and 1822D, respectively.

In some embodiments the memory controller 1802 is configured to determine which sockets in the memory system 1800 are populated with a memory module. In this case, the memory controller 1802 may configure the memory modules based on the detected configuration of the memory system 1800. To this end, the memory controller may include a configuration detector component 1818 that is adapted to communicate with the memory modules 1804 (e.g., via an SPID bus, not shown in FIG. 18) or sense signals at each socket to determine whether a given socket is populated and to determine the capabilities of each installed memory module 1804. In addition, the memory controller 1802 may include a mode control circuit that controls the configuration of the memory modules 1804 (e.g., via cooperation with an array controller 1816) based on the detected configuration. An example of operations that may be performed to configure a memory system will now be discussed in conjunction with FIG. 19.

For convenience, the operations of FIG. 19 (or any other operations discussed or taught herein) may be described as being performed by specific components (e.g., system 1800). It should be appreciated, however, that these operations may be performed by other types of components and may be performed using a different number of components. It also should be appreciated that one or more of the operations described herein may not be employed in a given implementation.

In the following discussion the alternative configurations of the memory modules may be referred to as having or using different data widths. It should be noted, however, that the capacities of the memory modules do not change with the different data widths, at least in the described embodiment. Rather, the full set of data of each module is available regardless of the data path width being used. With wider data widths, different subsets of memory subsections may be accessed through different sets of data connections. With narrower data widths, the different subsets of memory subsections may be accessed through a common set of data connections. At such narrower data widths, larger addressing ranges may be used to access the full set of data. For example, if the data width is reduced by a factor of two the addressing range may be increased by a factor of two (e.g., by using an additional address bit).

As represented by block 1902 in FIG. 19, initially one or more memory modules are installed in the memory system. This may involve, for example, inserting a memory module into a socket or attaching a memory module to a printed circuit board in some other manner as discussed herein. It should be appreciated that configuration of the memory system may take place when the system is initially placed in service and/or at some other time.

As represented by blocks 1904 and 1906, the appropriate interconnects are also installed at this time to couple the appropriate portions of the data bus to the memory module or memory modules. Referring to the example of FIGS. 3 and 4, in a first mode of operation both of the interconnect branches may be connected to a first memory module (block 1904). In contrast, in a second mode of operation one of the interconnect branches may be coupled to the first memory module and the other interconnect branch may be coupled to the second memory module (block 1906).

As represented by block 1908, once the memory system 1800 is powered up, the configuration detector 1818 may detect the configuration of the memory system 1800. As mentioned above, this may involve communicating with each of the installed memory modules 1804. The configuration detector 1818 may thus determine a mode of operation of the memory system 1800 (block 1910)

It should be appreciated that a variety of techniques may be employed to configure one or more of the components of a memory system. For example, in some embodiments a detachable interconnect includes a signal path for one or more bus select signals (e.g., for two bus pins). A full bus width connection (e.g., at a memory module) may be specified if both bus selects are set in a given manner (e.g., driven to a specified voltage level). Conversely, a half bus width connection may be specified if only one of the bus selects is set in the designated manner. Here, an appropriate voltage may be supplied by a power supply, generated from a resistive voltage divider, or correspond to a ground potential. Through the use of such a configuration detection mechanism, the number of pins needed on the memory controller for this purpose may be reduced (or entirely eliminated). In addition, the processing resources (e.g., protocol support) used by the system components (e.g., the memory controller) to support configuration detection may be reduced when techniques such as this are employed.

As represented by block 1912, the mode control circuit 1820 in conjunction with each array controller 1816 may configure the memory arrays 1812 in accordance with the current mode of operation. For example, as discussed herein the width of the data bus for each memory module 1804 may be adjusted along with the addressing range supported by each memory module 1804.

In view of the above, it should be appreciated that various modifications may be incorporated into the disclosed embodiments. For example, an interconnect apparatus may, in general, take a wide variety of forms. As mentioned above an interconnect apparatus may be relatively rigid or at least partially flexible. Also, in some embodiments an interconnect apparatus may be reconfigurable (e.g., detachable). In other embodiments the interconnect apparatus may be attached to one or more components in a relatively permanent manner.

Also, although the above description relates to a large extent to a memory system, it should be noted that the disclosed aspects of the different embodiments may be applicable to other types of systems that transfer data to and receive data from modules (e.g., installable modules). Thus, in some embodiments the sockets described herein may receive logic modules other than memory modules.

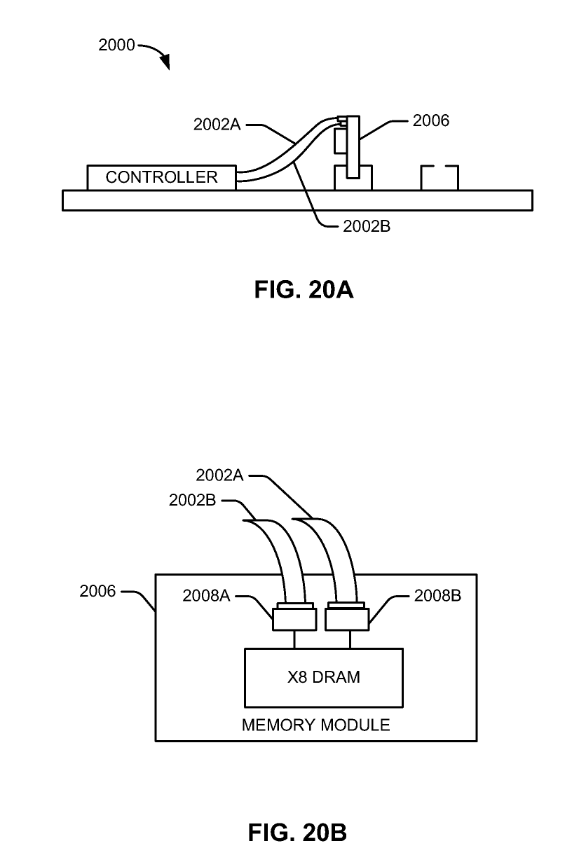

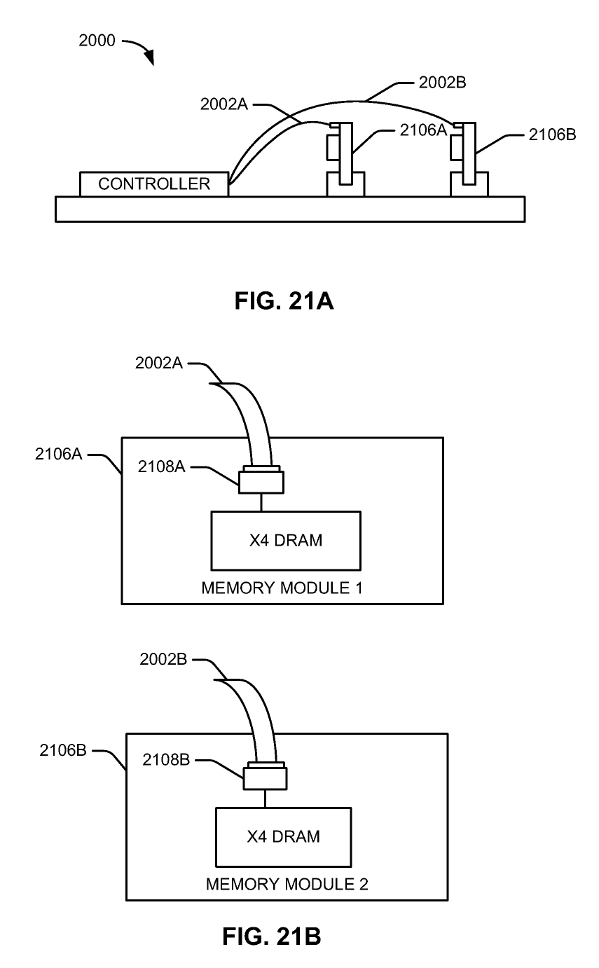

Moreover, many of the teachings herein are applicable to a memory system that does not employ reconfigurable memory modules. An example of such an embodiment will be described with reference to FIGS. 20 and 21. In the configuration of FIG. 20 only one memory module 2006 (e.g., an x8 DRAM module) is installed in the memory system 2000. In this case, all of the data bus branches (e.g., branches 2002A and 2002B) are connected to the module 2006. As shown in FIG. 20B, the memory module 2006 may include a two-channel (e.g., full bus width) connector component (e.g., a single connector or separate connectors 2008A and 2008B) for receiving the two branches 2002A and 2002B.

As illustrated in FIG. 21 the memory system may then be reconfigured by removing the single x8 DRAM module 2006 and installing two x4 DRAM modules (e.g., modules 2106A and 2106B). The branch 2002A is then connected to one module 2106A and the other branch 2002B is connected to the other module 2106B. As shown in FIG. 21B, the memory modules 2106A and 2106B may each include a one-channel (e.g., half bus width) connector component (e.g., connectors 2108A and 2108B, respectively) for receiving a respective one of the two branches 2002A and 2002B. Alternatively, each of the memory modules 2106A and 2106B may employ a full bus width connector (e.g., as depicted in FIG. 20) whereby only half of this connector is used.

A similar procedure may be followed in other embodiments to change the number and type of modules in the system. Here, the number of DRAMs needed depends on the DRAM bus width and the module bus width. For example, an x32 module may employ eight x4 DRAMs, four x8 DRAMs, two x16 DRAMs, or one x32 DRAM. In this case a “full width” module corresponds to an x32 module and a “half width” module corresponds to an x16 module. Also, the above concepts relating to full/half width may be applicable to full/half/quad width for a four module upgrade, and so on for systems that support greater numbers of modules.

It also should be appreciated that the various functional components and operations described herein may be implemented in various ways and using a variety of apparatuses. For example, a functional component may be implemented using various hardware components such a processor, a controller, a state machine, logic, or some combination of one or more of these components.

In some embodiments, code including instructions (e.g., software, firmware, middleware, etc.) may be executed on one or more processing devices to implement one or more of the described components or operations. The code and associated components (e.g., data structures and other components by the code or to execute the code) may be stored in an appropriate data memory that is readable by a processing device (e.g., commonly referred to as a computer-readable medium).

The recited order of the blocks in the processes disclosed herein is simply an example of a suitable approach. Thus, operations associated with such blocks may be rearranged while remaining within the scope of the present disclosure. Similarly, the accompanying method claims present operations in a sample order, and are not necessarily limited to the specific order presented.

The components and functions described herein may be connected or coupled in various ways. The manner in which this is done may depend, in part, on whether and how the components are separated from the other components. In some embodiments some of the connections or couplings represented by the lead lines in the drawings may be in an integrated circuit, on a circuit board, implemented as discrete wires, or implemented in some other way.

The signals discussed herein may take various forms. For example, in some embodiments a signal may comprise electrical signals transmitted over a wire, light pulses transmitted through an optical medium such as an optical fiber or air, or RF waves transmitted through a medium such as air, etc. In addition, a plurality of signals may be collectively referred to as a signal herein. The signals discussed above also may take the form of data. For example, in some embodiments an application program may send a signal to another application program. Such a signal may be stored in a data memory.

While certain sample embodiments have been described above in detail and shown in the accompanying drawings, it is to be understood that such embodiments are merely illustrative of and not restrictive of the teachings herein. In particular, it should be recognized that the teachings herein may apply to a wide variety of apparatuses and methods. It will thus be recognized that various modifications may be made to the illustrated embodiments and other embodiments as taught herein, without departing from the broad inventive scope thereof. In view of the above it will be understood that the teachings herein are not limited to the particular embodiments or arrangements disclosed, but are rather intended to cover any changes, adaptations or modifications which are within the scope of the appended claims.

What is claimed is:

1. A memory system, comprising:
a first socket to receive a first memory module;
a second socket to receive a second memory module;
a detachable signal-interconnect; and
a memory controller coupled to the detachable signal-interconnect and configured to define a first mode of operation and a second mode of operation, wherein in the first mode of operation the detachable signal-interconnect is to couple the memory controller to the first memory module and in the second mode of operation the detachable signal-interconnect is to couple the memory controller to the first memory module and the second memory module.

2. The memory system of claim 1, wherein:
in the first mode of operation the detachable signal-interconnect couples the memory controller to the first memory module in a point-to-point configuration; and
in the second mode of operation the detachable signal-interconnect couples the memory controller to the first memory module and the second memory module in a point-to-point configuration.

3. The memory system of claim 1, wherein:
the detachable signal-interconnect comprises a first branch and a second branch; and
the first branch of the detachable signal-interconnect is configured to carry a first portion of a data bus and the second branch of the detachable signal-interconnect is configured to carry a second portion of the data bus.

4. The memory system of claim 3, wherein:
in the first mode of operation the first and second branches of the detachable signal-interconnect are to couple the memory controller to the first memory module; and
in the second mode of operation the first branch of the detachable signal-interconnect is to couple the memory controller to the first memory module and second branch of the detachable signal-interconnect is to couple the memory controller to the second memory module.

5. The memory system of claim 1, wherein in the first mode of operation the first memory module is accessed at a first data bus width and in the second mode of operation the first memory module is accessed at a second data bus width that is different than the first data bus width.

6. The memory system of claim 1, wherein the memory controller is further configured to define the first and second modes of operation based on a determination of how many memory modules are installed in the memory system.

7. The memory system of claim 6, wherein the memory controller is further configured to generate a mode signal based on the determination to cause the first memory module to change a data width at which access to the first memory module is provided.

8. The memory system of claim 1, further comprising a connector attached to the memory controller to provide the coupling between the memory controller and the detachable signal-interconnect.

9. The memory system of claim 1, wherein an end portion of the detachable signal-interconnect is soldered to the memory controller.

10. The memory system of claim 1, wherein the second memory module comprises a connector to provide the coupling between the second memory module and the detachable signal-interconnect.

11. The memory system of claim 10, wherein the first memory module comprises another connector to provide the coupling between the first memory module and the detachable signal-interconnect.

12. The memory system of claim 1, wherein the first memory module comprises first and second connectors to provide the coupling between the first memory module and the detachable signal-interconnect in the first mode of operation.

13. The memory system of claim 1, wherein first socket comprises a passageway for a branch of the detachable signal-interconnect.

14. The memory system of claim 1, further comprising a printed circuit board having a set of traces that are adapted to couple the memory controller to the first memory module in the first and second modes of operation, wherein the detachable signal-interconnect is configured to carry a first portion of a data bus of the memory controller and the set of traces is configured to carry a second portion of the data bus.

15. The memory system of claim 1, wherein a portion of the detachable signal-interconnect is embedded in a printed circuit board.

16. The memory system of claim 1, wherein the detachable signal-interconnect comprises a plurality of circuit branches.

17. The memory system of claim 1, wherein the detachable signal-interconnect comprises a plurality of electrical conductors.

18. The memory system of claim 17, wherein the detachable signal-interconnect further comprises a controlled impedance circuit.

19. The memory system of claim 1, wherein the detachable signal-interconnect comprises at least one optical cable.

20. The memory system of claim 19, wherein the detachable signal-interconnect further comprises an optoelectronic circuit.

21. The memory system of claim 19, further comprising a connector attached to the memory controller to provide the coupling between the memory controller and the at least one optical cable, wherein the connector further comprises an optoelectronic circuit.

22. The memory system of claim 1, wherein the memory controller is directly connected to an end portion of the detachable signal-interconnect to couple signal paths associated with an entire width of the detachable signal-interconnect to the memory controller in the first mode of operation.

23. The memory system of claim 1, wherein:
the detachable signal-interconnect comprises a plurality of branches; and
the branches have substantially similar electrical path lengths.

24. The memory system of claim 1, wherein the detachable signal-interconnect comprises flex tape.

25. The memory system of claim 1, wherein the detachable signal-interconnect comprises a flexible circuit.

26. The memory system of claim 1, further comprising a set of printed circuit board traces coupled between the memory controller and the first socket.

27. The memory system of claim 1, wherein the signal-interconnect comprises a printed circuit board.

28. The memory system of claim 1, wherein:
the first memory module comprises a first type of memory module in the first mode of operation and a second type of memory module in the second mode of operation; and
the first type of memory module is different than the second type of memory module.

29. The memory system of claim 1, further comprising at least one other socket to receive at least one other memory module;
wherein in the second mode of operation the detachable signal-interconnect is to further couple the memory controller to the at least one other memory module.

30. The memory system of claim 29, wherein the at least one other memory module comprises a third memory module and a fourth memory module.

31. A memory controller, comprising:
a memory interface adapted to provide signals to access a plurality of memory devices;
a set of contacts coupled to the memory interface and adapted to couple with a detachable signal-interconnect; and
a mode control circuit configured to define a first mode of operation and a second mode of operation, wherein in the first mode of operation the set of contacts is coupled to a first one of the memory devices and in the second mode of operation the set of contacts is coupled to the first one and a second one of the memory devices.

32. The memory controller of claim 31, further comprising a configuration detector configured to determine how many memory modules are installed in the memory system.

33. The memory controller of claim 31, wherein the mode control circuit is further configured to generate a mode signal to cause the first one of the memory devices to change a data width at which access to the first one of the memory devices is provided.

34. The memory controller of claim 31, wherein the first mode of operation is associated with a first width for data transfer to and from a memory device and the second mode of operation is associated with a second width for data transfer to and from the memory device.

35. The memory controller of claim 31, wherein the memory interface is further configured to provide the signals via point-to-point signal paths in the first and second modes of operation.

36. The memory controller of claim 31, further comprising a connector connected to the set of contacts to provide the coupling with the detachable signal-interconnect.

37. The memory controller of claim 31, wherein the detachable signal-interconnect is soldered to the set of contacts.

38. The memory controller of claim 31, wherein the detachable signal-interconnect comprises a controlled impedance circuit.

39. The memory controller of claim 31, wherein:
the detachable signal-interconnect comprises at least one optical cable;
the memory controller further comprises a connector to provide the coupling with the at least one optical cable; and
the connector comprises an optoelectronic circuit.

40. The memory controller of claim 31, wherein the detachable signal-interconnect is attached to a substrate of the memory controller.

41. A memory module, comprising:
at least one memory device; and
a first set of contacts adapted to couple with a first detachable signal-interconnect; and
a second set of contacts adapted to couple with a second detachable signal-interconnect,
wherein in a first mode of operation access to the at least one memory device is provided via the first set of contacts and in a second mode of operation access to the at least one memory device is provided via the first and second sets of contacts.

42. The memory module of claim 41, further comprising:
a first connector connected to the first set of contacts to provide the coupling with the first detachable signal-interconnect; and
a second connector connected to the second set of contacts to provide the coupling with the second detachable signal-interconnect.

43. The memory module of claim 42, wherein the first and second connectors comprise optoelectronics.

44. The memory module of claim 41, wherein:
the at least one memory device comprises a plurality of memory devices;
in the first mode of operation, the first set of contacts is coupled to all of the memory devices; and
in the second mode of operation, the first and second sets of contacts are coupled to all of the memory devices.

45. The memory module of claim 41, further comprising an array controller configured to:
in the first mode of operation, provide access to the first memory device at a first data bus width; and
in the second mode of operation, provide access to the first memory device at a second data bus width that is different than the first data bus width.

46. A memory device, comprising:
a memory array; and
a set of contacts adapted to couple the memory array to a detachable signal-interconnect;
wherein in a first mode of operation access to the memory array is provided at a first data bus width and in a second mode of operation access to the memory array is provided at a second data bus width that is different than the first data bus width.

47. The memory device of claim 46, further comprising a connector connected to the set of contacts to provide the coupling with the detachable signal-interconnect.

48. The memory device of claim 47, wherein the connector comprises optoelectronics.

49. The memory device of claim 46, wherein the detachable signal-interconnect comprises a first branch and a second branch, and the memory device further comprises:
a first connector connected to a first portion of the set of contacts to provide the coupling of the memory array to the first branch of the detachable signal-interconnect; and
a second connector connected to a second portion of the set of contacts to provide the coupling of the memory array to the second branch of the detachable signal-interconnect.

50. The memory device of claim 46, wherein:
the memory array comprises a plurality of memory subsections;
in the first mode of operation, the set of contacts corresponding to the first data bus width is coupled to all of the memory subsections; and
in a second mode of operation, a portion of the set of contacts corresponding to the second data bus width is coupled to all of the memory subsections.

51. A method of accessing memory in a memory system, comprising:
determining a configuration of the memory system; and
selecting a first mode of operation or a second mode of operation based on the determined configuration, wherein in the first mode of operation a first memory device is accessed via a detachable signal-interconnect and in the second mode of operation the first memory device and a second memory device are accessed via the detachable signal-interconnect.

52. The method of claim 51, wherein:
in the first mode of operation the first memory device is accessed via a first branch and a second branch of the detachable signal-interconnect; and
in the second mode of operation the first memory device is accessed via the first branch of the detachable signal-interconnect and the second memory device is accessed via the second branch of the detachable signal-interconnect.

53. The method of claim 52, wherein the first branch of the detachable signal-interconnect carries a first portion of a data bus and the second branch of the detachable signal-interconnect carries a second portion of the data bus.

54. The method of claim 51, wherein:
the first memory device is accessed via a set of traces in a printed circuit board;
the detachable signal-interconnect carries a first portion of a data bus; and
the set of traces carries a second portion of the data bus.

55. The method of claim 51, wherein the determination of the configuration comprises determining how many memory modules are installed in the memory system.

56. The method of claim 51, further comprising selecting a data bus width of the first memory device based on the selected mode of operation.

57. The method of claim 51, wherein in the first mode of operation the first memory device is accessed at a first data bus width and in the second mode of operation the first memory device is accessed at a second data bus width that is narrower than the first data bus width.

58. The method of claim 51, wherein:
in the first mode of operation the detachable signal-interconnect couples a memory controller to the first memory device in a point-to-point configuration; and
in the second mode of operation the detachable signal-interconnect couples the memory controller to each of the first memory device and the second memory device in a point-to-point configuration.

59. The method of claim 58, wherein the detachable signal-interconnect further comprises a controlled impedance circuit.

60. The method of claim 51, wherein the second memory device comprises a connector for coupling with the detachable signal-interconnect.

61. The method of claim 51, wherein the detachable signal-interconnect comprises an optical cable.

62. A memory system, comprising:
a first memory module;
a socket to receive a second memory module;
a detachable signal-interconnect; and
a memory controller coupled to the detachable signal-interconnect and configured to define a first mode of operation and a second mode of operation, wherein in the first mode of operation the detachable signal-interconnect is to couple the memory controller to the first memory module and in the second mode of operation the detachable signal-interconnect is to couple the memory controller to the second memory module.

63. The memory system of claim 62, further comprising a printed circuit board having a set of traces that are adapted to couple the memory controller to the first memory module in a point to point configuration in the first and second modes of operation; wherein:
the detachable signal-interconnect is configured to carry a first portion of a data bus of the memory controller and the set of traces is configured to carry a second portion of the data bus.

64. The memory system of claim 63, wherein the first memory module is attached to the printed circuit board.

65. The memory system of claim 63, wherein the first memory module is soldered to the printed circuit board.

66. The memory system of claim 63, wherein the first memory module is clamped to the printed circuit board.

67. The memory system of claim 62, wherein:
in the first mode of operation the detachable signal-interconnect couples the memory controller to the first memory module in a point-to-point configuration; and
in the second mode of operation the detachable signal-interconnect couples the memory controller to the second memory module in a point-to-point configuration.

68. The memory system of claim 62, wherein in the first mode of operation the first memory module is accessed at a first data bus width and in the second mode of operation the first memory module is accessed at a second data bus width that is different than the first data bus width.

69. The memory system of claim 62, wherein the memory controller is further configured to define the first and second modes of operation based on a determination of how many memory modules are installed in the memory system.

70. The memory system of claim 69, wherein the memory controller is further configured to generate a mode signal based on the determination to cause the first memory module to change a data width at which access to the first memory module is provided.

71. The memory system of claim 62, further comprising a connector attached to the memory controller to provide the coupling between the memory controller and the detachable signal-interconnect.

72. The memory system of claim 62, wherein an end portion of the detachable signal-interconnect is soldered to the memory controller.

73. The memory system of claim 62, wherein the second memory module comprises a connector to provide the coupling between the second memory module and the detachable signal-interconnect.
